(19) United States
(12) Patent Application Publication
(10) Pub. No.: US 2006/0194699 A1
(43) Pub. Date: Aug. 31, 2006

(54) Sprayable non-aqueous, oil-continuous microemulsions and methods of making same

(76) Inventors: Nadim C Moucharafieh, El Sobrante, CA (US); Mark R Bauer, Delaware, OH (US); Brian Graham, Dublin, OH (US); John R Finney, Dublin, OH (US); Jeffrey Calmeyer, Columbus, OH (US); Robert J Fellows, Richland, WA (US)

Correspondence Address: BATTELLE MEMORIAL INSTITUTE, 505 KING AVENUE, COLUMBUS, OH, 43201-2693, US

(21) Appl. No.: 10/541,685

(22) PCT Filed: Jan. 10, 2004
(86) PCT No.: PCT/US04/00554

§ 371 Date: Dec. 16, 2005

Related U.S. Application Data
(60) Provisional application No. 60/439,256, filed on Jan. 10, 2003.

(51) Int. Cl. A01N 57/18; A01N 25/04

(52) U.S. Cl. 504/206; 504/365

(57) ABSTRACT

Non-aqueous, oil-continuous microemulsions and methods of making such microemulsions are provided. The non-aqueous, oil-continuous microemulsions comprise at least one oil component, at least one non-aqueous polar solvent component, at least one amphiphilic material component, and at least one solubilized polar compound component. The solubilized polar compound can be a polar-acidic agrochemical complex such as glyphosate. The microemulsions can be applied by either conventional mechanical, non-electrostatic or by electrostatic LV or ULV techniques, such as, for example, electrohydrodynamic spraying, and exhibit enhanced pesticidal activity.

The present invention relates to oil-continuous microemulsions and, more particularly, to non-aqueous, oil-continuous microemulsions and methods of making same that are sprayable via electrostatic and non-electrostatic means. Many chemical formulations used for crop protection and pest control, such as fungicides, herbicides, insecticides, acaricides, miticides, molluscicides, nematicides, rodenticides, plant-desiccants, plant-growth regulators, etc. (pesticides in general), are sprayable aqueous liquids that cover a target area (e.g., the surface of a plant) to effect their intended purpose. More specifically in some applications, an agricultural pesticide (either single or in combination with other compounds) needs to be in the liquid phase in order for it to penetrate the leaf cuticle of a target weed or plant or the cuticle of a target insect or similar pest. In order for the sprayed formulation to remain on the target, it needs to wet the surface. However, plant leaves often have waxy surfaces and both plants and insects can have tiny hairs that make it difficult for aqueous sprays to stick. Consequently, surface-active agents (e.g., wetting agents, surfactants, and other amphiphiles) are often utilized. These materials lower the interfacial tension between the sprayed aqueous liquid and the surface of the target, and permit the aqueous spray to stay on the target. Additionally, the formulation(s) may contain other ingredient(s) like spreaders, stickers, humectants, emollients, etc.

In sprayed formulations that contain a contact herbicide, the active agent does not need to translocate to be effective. Alternatively, in systemic herbicidal formulations, the agent must penetrate the leaf cuticle and translocate (i.e., be transported) within the plant to the site where it may exert its intended biological function. PMG acid (N-phosphonomethylglycine or “glyphosate”) and other similar acidic herbicides (e.g., glufosinate and 2,4-D) are known systemic herbicides.

These materials, however, are insoluble solids. Several compounds of PMG have been prepared that are water-soluble and that lend themselves to application by mechanical spraying on the target vegetation. With the aid of special surface-active materials (e.g., alkylamine ethoxylates and propoxylates, alkyl polyglucosides, etc.), formulations of PMG are able to penetrate the leaf cuticle and become effective herbicides. Several commercial formulations of PMG compounds, which are intended as systemic herbicides, are available (i.e., Roundup® herbicide available from Monsanto Company, St. Louis, Mo. and Touchdown® herbicide available from Syngenta Crop Protection, Greensboro, N.C.). The following U.S. patents and international application disclose PMG and other water-soluble herbicidal formulations: U.S. Pat. Nos. 3,977,860 and 3,948,975 to Franz; U.S. Pat. No. 5,668,085 to Forbes et al.; U.S. Pat. Nos. 5,300,680 and 5,410,074 to Jones et al.; U.S. Pat. No. 5,658,853 to Kassebaum et al.; U.S. Pat. No. 5,565,409 to Sato et al.; and WO 01189302 A2 by Lennon et al.

Water, which is used as a solvent/diluent or carrier in the above-referenced systems, has its volatility as a limiting factor. As such, the full potency of the herbicide may not be utilized. This is due to the fact that in an aqueous spray, the water may evaporate and a significant portion of the sprayed herbicide could be left (as solid) on the leaf surface. Furthermore, mechanical spraying of liquid formulations generates droplets of various sizes ranging from over 200 microns down to less than 10 microns. Larger droplets may hit the leaf surface and fragment and/or bounce off. The smaller droplets (less than 50 microns) can drift away or may dry or volatilize before contacting the leaf surface. The result is a lowering in the efficacy of the herbicide employed.

Non-volatile oils have been used for general or non-electrostatic, low-volume (“LV”) and ultra-low volume (“ULV”) application of herbicides. However, PMG and other similar herbicidal compounds are insoluble in such oils. In an attempt to solve such insolubility issues, water-in-oil emulsions containing water-soluble herbicides have been used for general mechanical as well as electrostatic LV and ULV application. (See, i.e., GB 2 022 418 A to Lawrence, Coffee and Robert). These formulations, however, still suffer from the volatility of the water droplets dispersed in the oil, as a large portion of the applied or sprayed active agent either remains on the leaf surface as a dry residue or drifts/diffuses away as a fine mist. Moreover, such water-in-oil emulsions are impractical for commercial spray application given that they are prone to separation upon standing and are highly viscous.

Accordingly, there is a recognized need for improvements in sprayable formulation design.

The present invention meets the above-mentioned need by providing sprayable, non-aqueous, oil-continuous microemulsions and methods of making such microemulsions, which contain a formulation with a desired biological function.

Although the present invention is not limited to specific advantages or functionality, it is noted that non-aqueous, oil-continuous microemulsions provide essentially non-volatile solvents for polar-acidic agrochemical complexes such as, for example, a PMG compound. By “essentially non-volatile” we mean that the vapor pressure of the solvents employed in the present invention is less than that of solvents containing water. Additionally, non-aqueous polar liquids are better solvents for PMG compounds than water, and the resulting solutions can contain up to 60% or more by weight acid equivalent. These completely non-aqueous solutions circumvent the volatility problems of known aqueous formulations of PMG. The latter solutions are used to prepare the non-aqueous, oil-continuous microemulsions of the present invention. The resulting microemulsions may be applied by either conventional mechanical, non-electrostatic or by electrostatic LV or ULV techniques. By “electrostatic techniques”, we mean both conventional electrostatic spraying; and electric field spraying also known as electric field effect technology (EFET). EFET includes: electrohydrodynamic aerosolization (EHD) (also referred to herein as electrohydrodynamic spraying); and electrospinning; and any other conceivable technique that is effective in producing an electric field induced cone-jet or Taylor cone for application of particles or material to a target. These microemulsion formulations exhibit enhanced herbicidal activity.

As illustrated in further detail herein, post-emergence herbicidal spray compositions prepared in accordance with the present invention as non-aqueous, oil-continuous microemulsions show superior biological efficacy (i.e., long term weed control) with a reduction in the active ingredient dose applied when compared to conventional water-based formulations of PMG (i.e., Roundup® ULTRA MAX) in both glass-house and randomized, multiple-plot field trials. In contrast to such water-based formulations of PMG, the herbicidal performance exhibited by the non-aqueous formulations of the present invention is impervious of weed growth stage. Moreover, the onset of visual symptoms of herbicidal activity, including necrosis, is much more rapid and obvious when employing the non-aqueous, oil-continuous microemulsions of the present invention, as compared to conventional aqueous formulations of PMG. Without wishing to limit the invention to any particular theory or mechanism of operation, it is believed that the addition of particular oils, such as, for example, alkyl esters of fatty acids (i.e., methyl oleate), can have the effect of increasing uptake and translocation of certain solubilized polar herbicidal compounds within the plant, and thus improve long term weed control.

In one embodiment of the present invention, a non-aqueous, oil-continuous microemulsion is provided comprising at least one oil component, at least one non-aqueous polar solvent component, at least one amphiphilic material component, and at least one solubilized polar compound component. The solubilized polar compound can be a polar agrochemical complex and, more particularly, a polar-acidic agrochemical complex, such as, for example, a glyphosate complex, a 2,4-D complex, a glufosinate complex, and combinations thereof. As mentioned above, the oil component can be an alkyl ester of a fatty acid, such as, for example, methyl oleate.

In another embodiment of the present invention, a method for solubilizing a polar compound into a non-aqueous, oil-continuous microemulsion is provided. The method comprises providing a polar portion, mixing an amphiphilic material (i.e., a cationic surfactant) with the polar portion to produce an intermediate mixture, and adding an oil component to the intermediate mixture, together with vigorous mixing. The polar portion can be prepared by: (a) providing a non-aqueous, polar solvent; (b) providing an insoluble, solid polar compound and combining the polar compound with the non-aqueous, polar solvent to form a reaction mixture; and (c) providing a compound having an amine, sulfonium, sulfoxonium, amide or ester functional group and adding it to the reaction mixture to form a salt, amide or ester of the polar compound, which forms a stock solution of a soluble salt, amide or ester of the polar compound by mixing and/or heating the reaction mixture. Optionally, a second amphiphilic material, such as a non-ionic surfactant, can be added together with vigorous mixing to form the non-aqueous, oil-continuous microemulsion of the present invention.

In yet another embodiment of the present invention, a post-emergence herbicidal spray composition comprising a non-aqueous, oil-continuous microemulsion is provided. The microemulsion comprises at least one oil component, at least one non-aqueous polar solvent component, at least one amphiphilic material component, and at least one solubilized polar compound component. The solubilized polar compound component can comprise a polar-acidic agrochemical complex selected from a glyphosate complex, a 2,4-D complex, a glufosinate complex, and combinations thereof.

In still another embodiment of the present invention, a method of controlling weeds is provided which comprises applying a post-emergence herbicidal spray composition to a target plant. The composition comprises a non-aqueous, oil-continuous microemulsion comprising at least one oil component, at least one non-aqueous polar solvent component, at least one amphiphilic material component, and at least one solubilized polar compound component that comprises a polar-acidic agrochemical complex selected from a glyphosate complex, a 2,4-D complex, a glufosinate complex, and combinations thereof. The step of applying the post-emergence herbicidal spray composition to the target plant can be performed by either conventional mechanical, non-electrostatic or by electrostatic low-volume or ultra-low volume techniques.

In yet still another embodiment of the present invention, a method of improving the uptake and translocation of a systemic herbicidal compound in a target plant is provided which comprises applying a post-emergence herbicidal spray composition to the target plant. The composition comprises a non-aqueous, oil-continuous microemulsion comprising at least one oil component, at least one non-aqueous polar solvent component, at least one amphiphilic material component, and at least one solubilized polar compound component that comprises a polar-acidic agrochemical complex selected from a glyphosate complex, a 2,4-D complex, a glufosinate complex, and combinations thereof. The oil component, which can comprise methyl oleate, affects the improved uptake and translocation of the solubilized polar compound in the target plant.

In yet still another embodiment of the present invention, a post-emergence herbicidal spray composition comprising a non-aqueous, oil-continuous microemulsion is provided. The microemulsion is characterized by a pH of less than 7.00 at about 22° C.

In yet still another embodiment of the present invention, a method of controlling weeds is provided which comprises applying a post-emergence herbicidal spray composition to a target plant. The composition comprises a non-aqueous, oil-continuous microemulsion that is characterized by a pH of less than 7.00 at about 22° C. The step of applying the post-emergence herbicidal spray composition to the target plant is performed by either conventional mechanical, non-electrostatic or by electrostatic low-volume or ultra-low volume techniques.

In yet still another embodiment of the present invention, a post-emergence herbicidal spray composition comprising a non-aqueous, oil-continuous microemulsion is provided. The microemulsion is characterized by an octonal/water partitioning coefficient of between about 2 and about 4 k_{ow}.

In yet still another embodiment of the present invention, a method of controlling weeds is provided which comprises applying a post-emergence herbicidal spray composition to a target plant. The composition comprises a non-aqueous, oil-continuous microemulsion that is characterized by an octonal/water partitioning coefficient of between about 2 and about 4 k_{ow}. The step of applying the post-emergence herbicidal spray composition to the target plant is performed by either conventional mechanical, non-electrostatic or by electrostatic low-volume or ultra-low volume techniques.

In yet still another embodiment of the present invention, a method of controlling weeds is provided which comprises applying a post-emergence herbicidal spray composition to a target plant. The composition comprises a non-aqueous, oil-continuous microemulsion. The step of applying the post-emergence herbicidal spray composition to the target plant is performed by either conventional mechanical, non-electrostatic or by electrostatic low-volume or ultra-low volume techniques, which deliver a droplet size of between about 5 and about 30 microns to the target plant.

In yet still another embodiment of the present invention, a method of improving the uptake and translocation of a systemic insecticidal or fungicidal compound in a target plant is provided which comprises applying an insecticidal or fungicidal spray composition to the target plant. The composition comprises a non-aqueous, oil-continuous microemulsion that comprises at least one oil component, at least one non-aqueous polar solvent component, at least one amphiphilic material component, and at least one solubilized polar compound component that comprises a polar-acidic agrochemical complex. The oil component, which can comprise methyl oleate, affects the improved uptake and translocation of the solubilized polar compound in the target plant.

In yet still another embodiment of the present invention, method of controlling insects or fungi is provided which comprises applying an insecticidal or fungicidal spray composition to a target plant. The composition comprises a non-aqueous, oil-continuous microemulsion, and the step of applying an insecticidal or fungicidal spray composition to a target plant is performed by either conventional mechanical, non-electrostatic or by electrostatic low-volume or ultra-low volume techniques, which deliver a droplet size of between about 5 and about 30 microns to the target plant.

In yet still another embodiment of the present invention, a method of controlling weeds is provided which comprises applying a post-emergence herbicidal spray composition to a target plant. The composition comprises a non-aqueous, oil-continuous microemulsion. The step of applying the post-emergence herbicidal spray composition to the target plant is performed by either conventional mechanical, non-electrostatic or by electrostatic techniques, which deliver a volume of formulated product to a target plant, at a potential volume rate ranging from ultra-low volumes (less than about 5 Its/ha) through to high volumes (greater than about 500 lts/ha).

These and other features and advantages of the invention will be more fully understood from the following detailed description of the invention. It is noted that the scope of the claims is defined by the recitations therein and not by the specific discussion of features and advantages set forth in the present description.

The following detailed description of the embodiments of the present invention can be best understood when read in conjunction with the following drawings, where like structure is indicated with like reference numerals and in which:

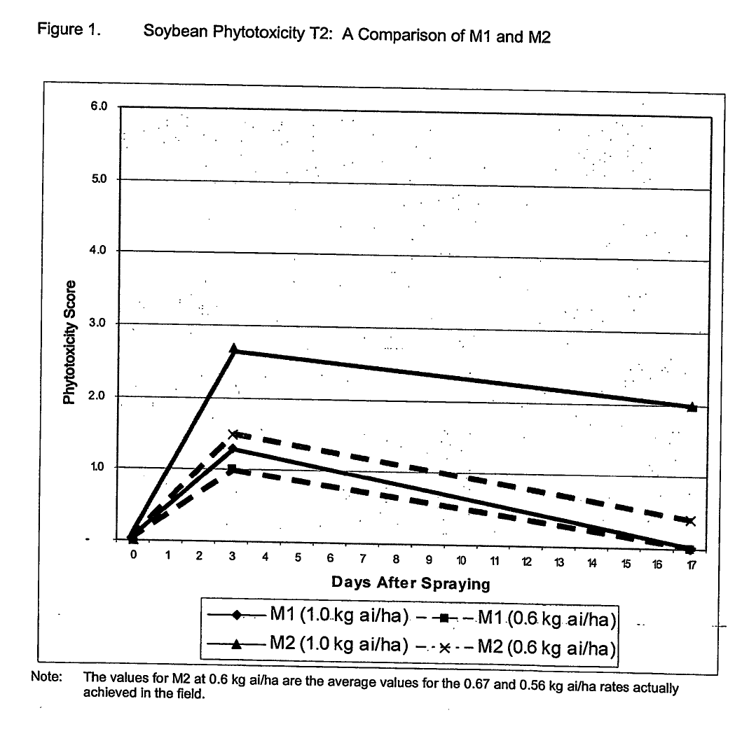

FIG. 1 is a plot diagram showing soybean phytotoxicity after a second application of two experimental PMG-based formulations;

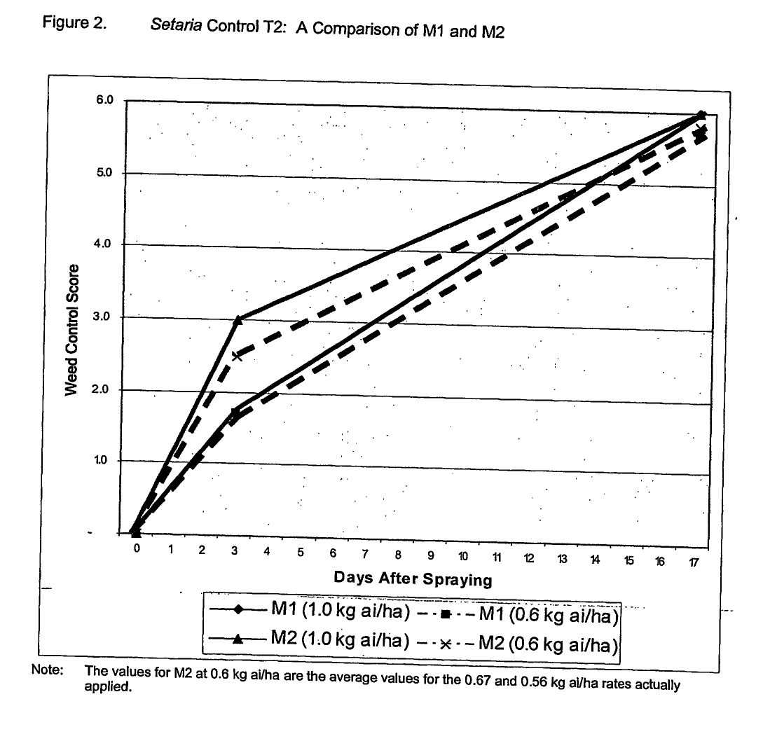

FIG. 2 is a plot diagram showing Setaria control after a second application of two experimental PMG-based formulations;

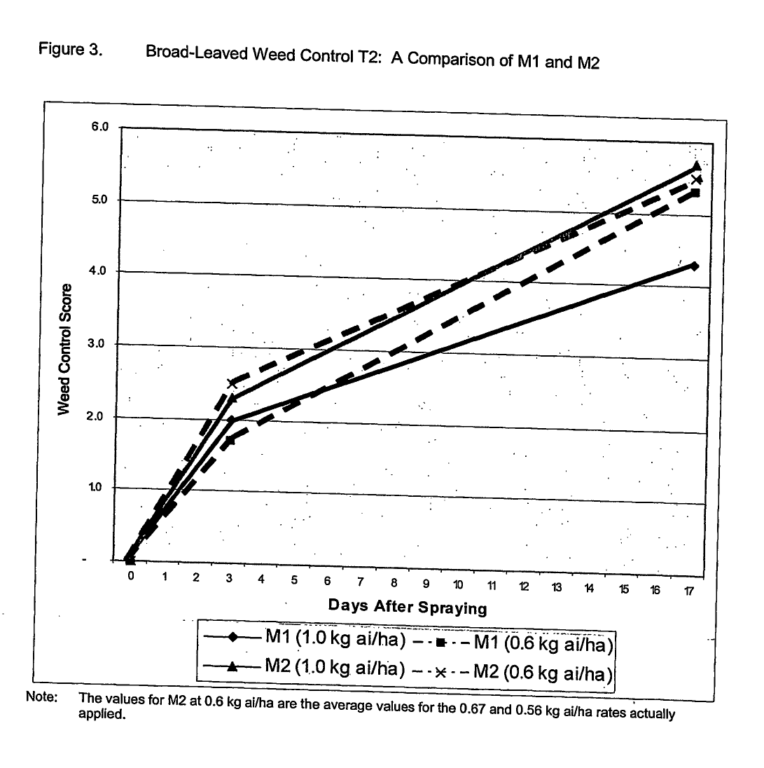

FIG. 3 is a plot diagram showing broad-leaved weed control after a second application of two experimental PMG-based formulations;

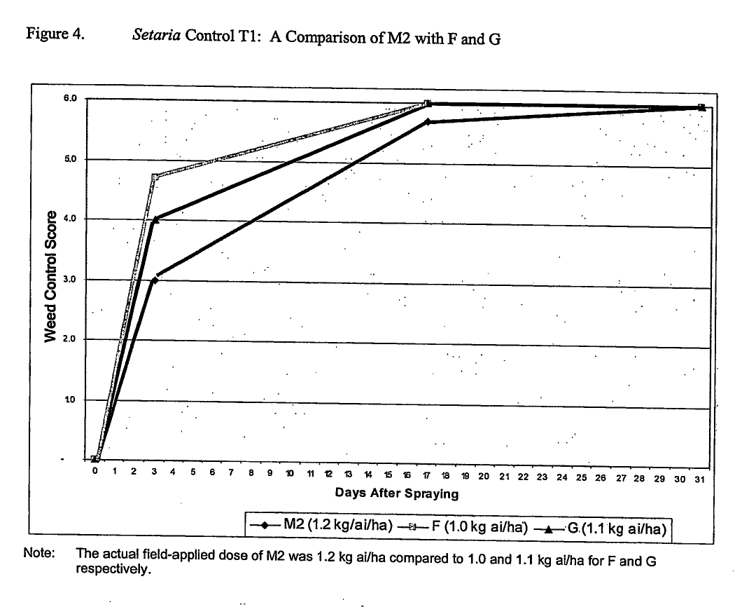

FIG. 4 is a plot diagram showing Setaria control after a first application of two novel post-emergence herbicidal spray compositions prepared in accordance with the present invention, which are compared to another experimental PMG-based formulation;

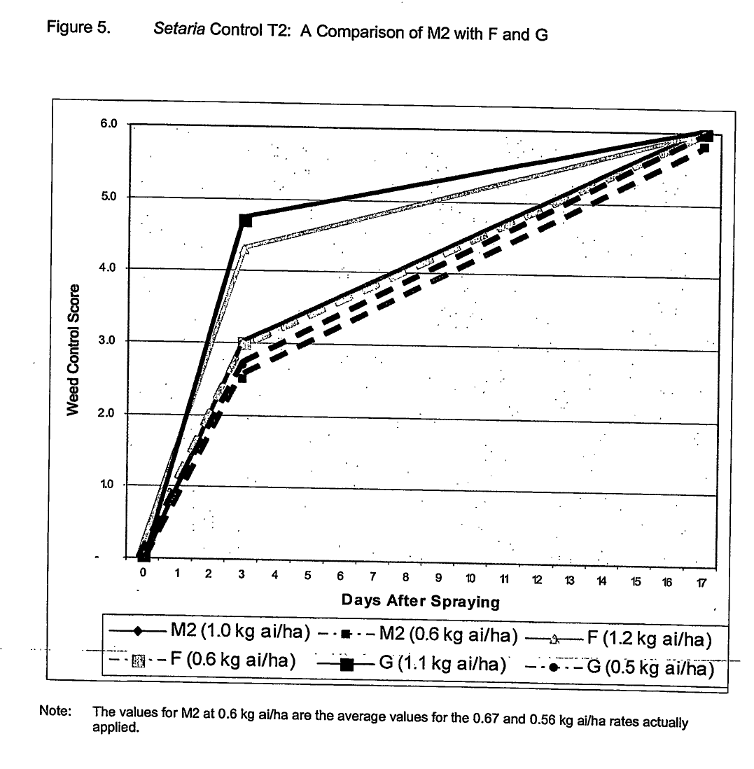

FIG. 5 is a plot diagram showing Setaria control after a second application of two novel post-emergence herbicidal spray compositions prepared in accordance with the present invention, which are compared to another experimental PMG-based formulation;

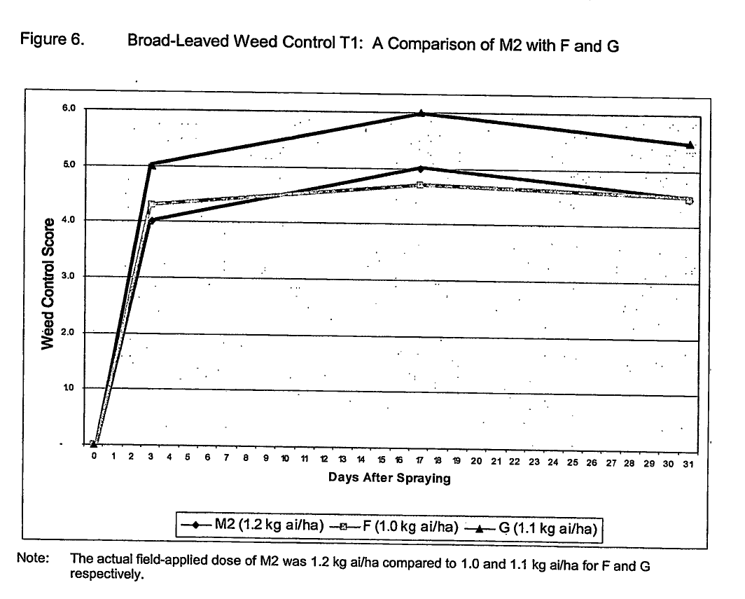

FIG. 6 is a plot diagram showing broad-leaved weed control after a first application of two novel post-emergence herbicidal spray compositions prepared in accordance with the present invention, which are compared to another experimental PMG-based formulation;

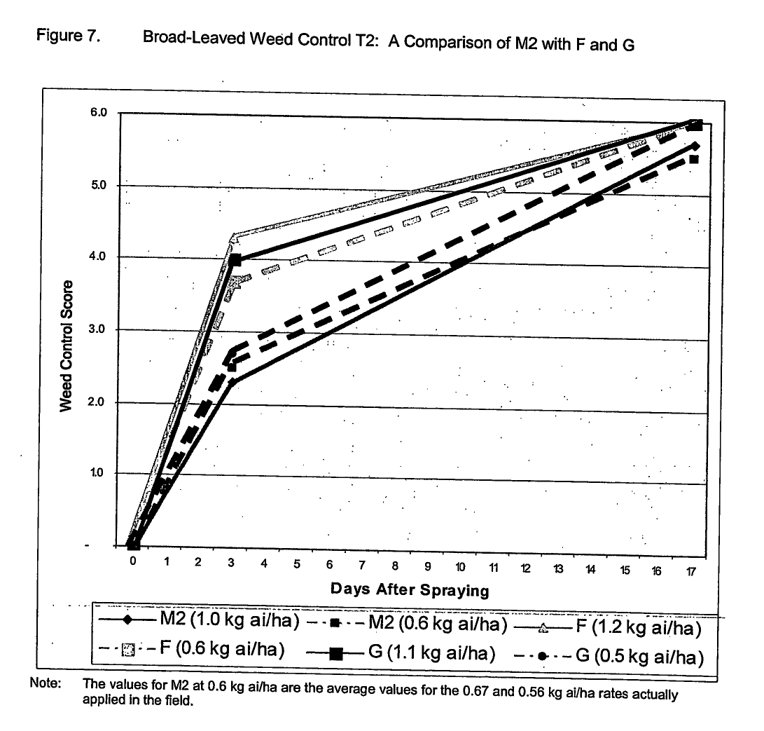

FIG. 7 is a plot diagram showing broad-leaved weed control after a second application of two novel post-emergence herbicidal spray compositions prepared in accordance with the present invention, which are compared to another experimental PMG-based formulation;

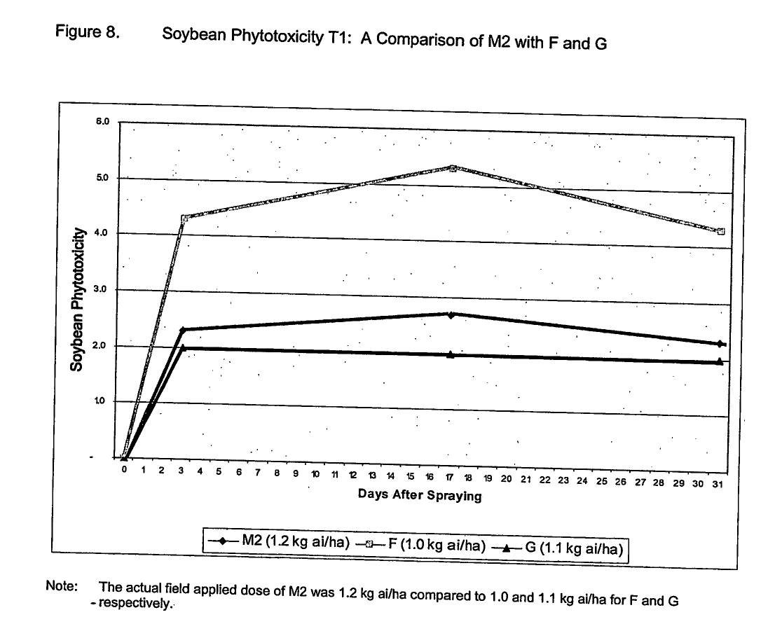

FIG. 8 is a plot diagram showing soybean phytotoxicity after a first application of two novel post-emergence herbicidal spray compositions prepared in accordance with the present invention, which are compared to another experimental PMG-based formulation;

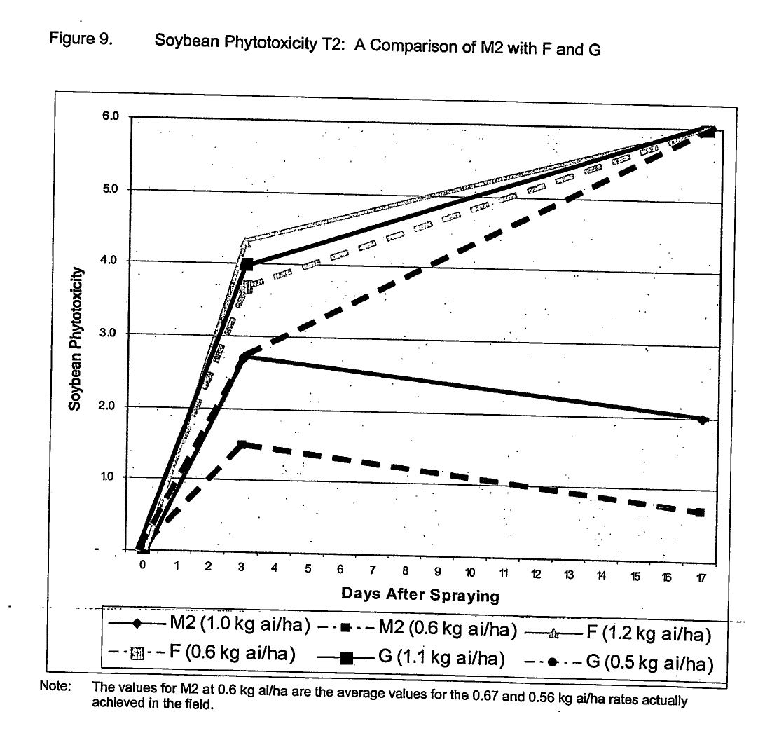

FIG. 9 is a plot diagram showing soybean phytotoxicity after a second application of two novel post-emergence herbicidal spray compositions prepared in accordance with the present invention, which are compared to another experimental PMG-based formulation;

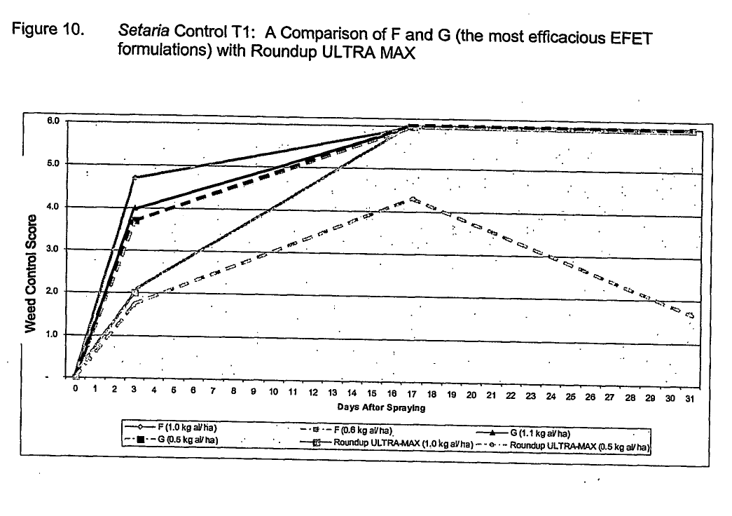

FIG. 10 is a plot diagram showing Setaria control after a first application of two novel post-emergence herbicidal spray compositions prepared in accordance with the present invention, which are compared to Roundup® ULTRA MAX;

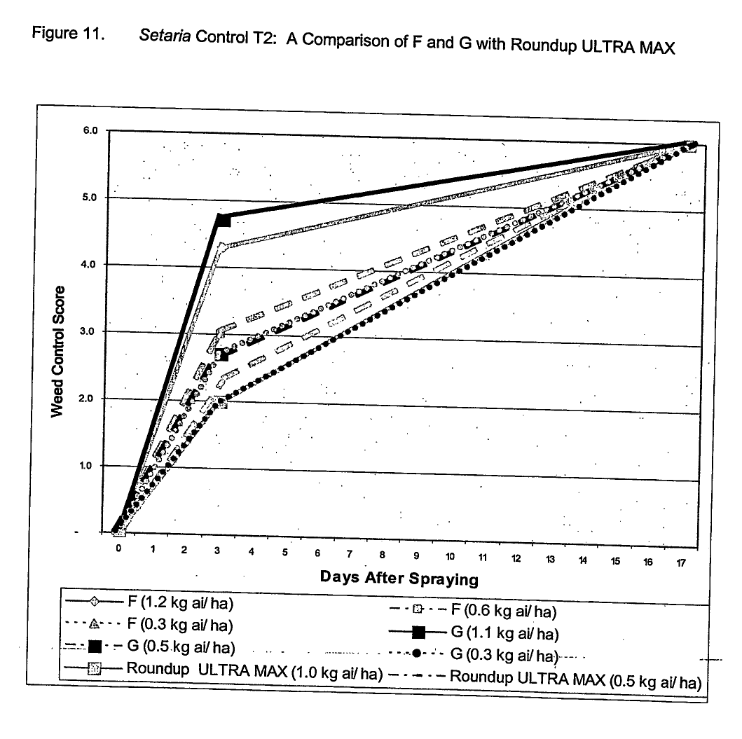

FIG. 11 is a plot diagram showing Setaria control after a second application of two novel post-emergence herbicidal spray compositions prepared in accordance with the present invention, which are compared to Roundup® ULTRA MAX;

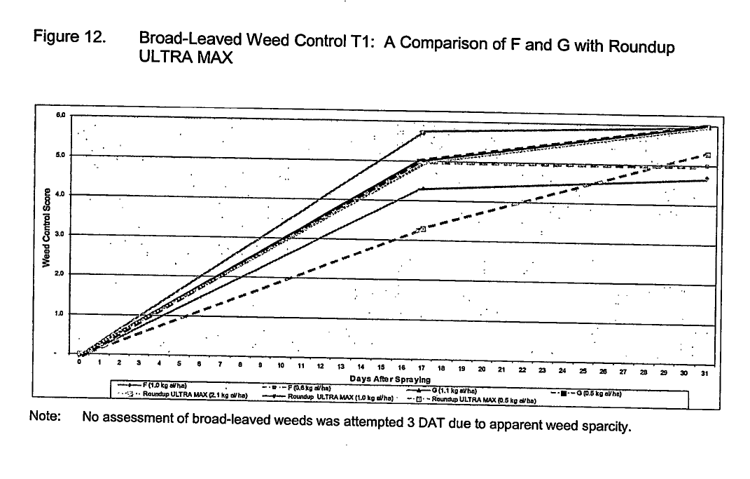

FIG. 12 is a plot diagram showing broad-leaved weed control after a first application of two novel post-emergence herbicidal spray compositions prepared in accordance with the present invention, which are compared to Roundup® ULTRA MAX;

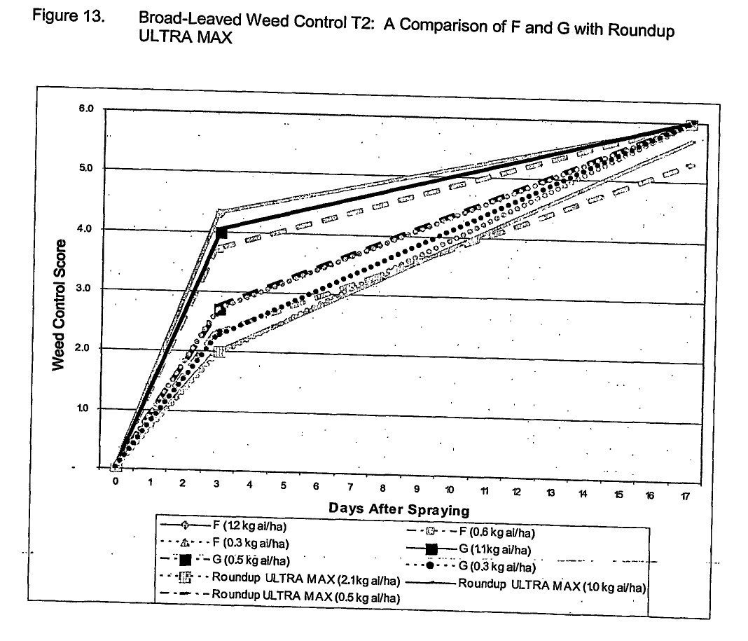

FIG. 13 is a plot diagram showing broad-leaved weed control after a second application of two novel post-emergence herbicidal spray compositions prepared in accordance with the present invention, which are compared to Roundup® ULTRA MAX;

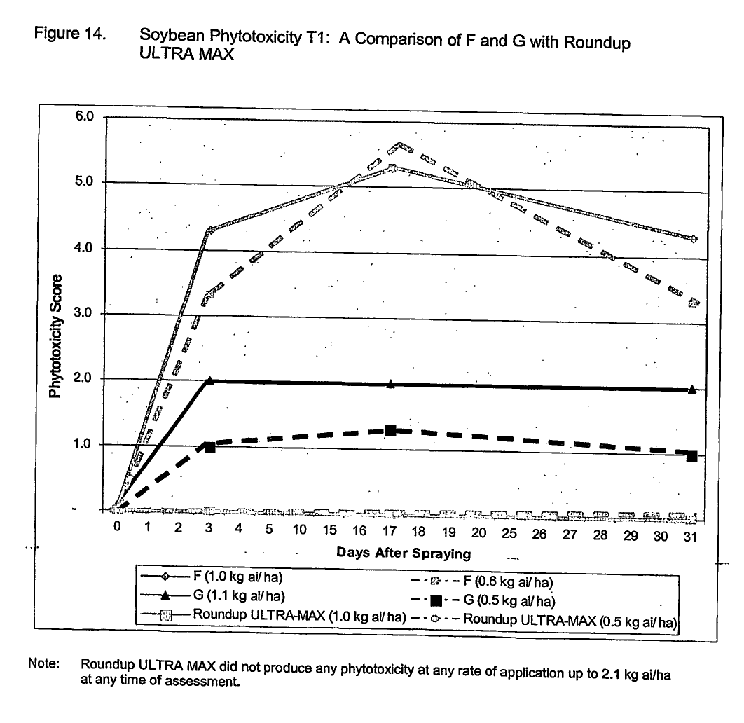

FIG. 14 is a plot diagram showing soybean phytotoxicity after a first application of two novel post-emergence herbicidal spray compositions prepared in accordance with the present invention, which are compared to Roundup® ULTRA MAX;

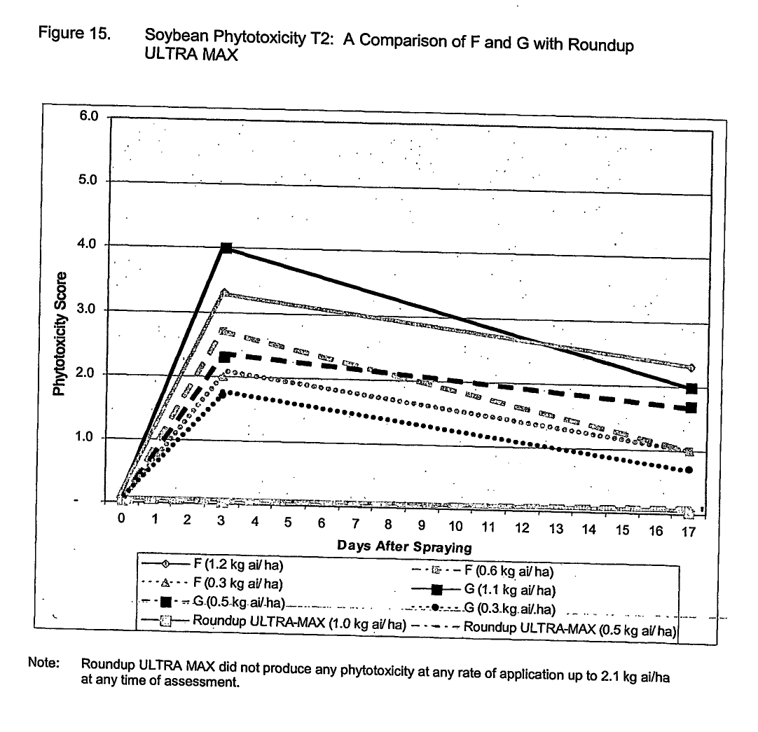

FIG. 15 is a plot diagram showing soybean phytotoxicity after a second application of two novel post-emergence herbicidal spray compositions prepared in accordance with the present invention, which are compared to Roundup® ULTRA MAX;

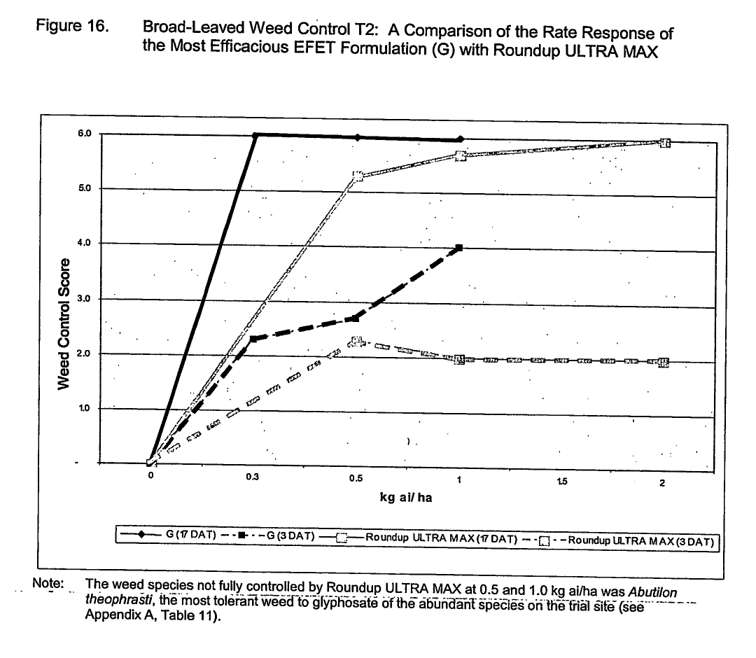

FIG. 16 is a plot diagram showing the rate response of broad-leaved weed control after a second application of one novel post-emergence herbicidal spray composition prepared in accordance with the present invention, which is compared to Roundup® ULTRA MAX;

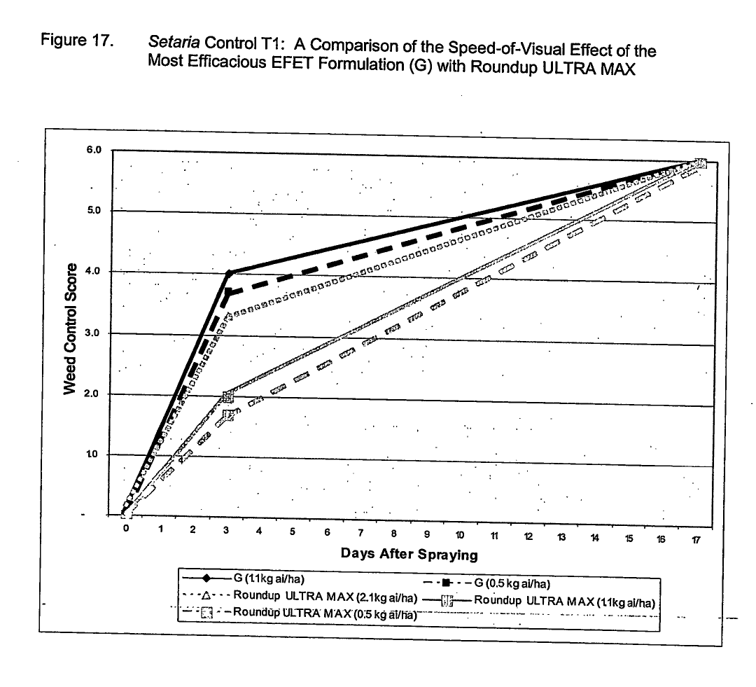

FIG. 17 is a plot diagram showing the speed-of-visual effect of Setaria control after a first application of one novel post-emergence herbicidal spray composition prepared in accordance with the present invention, which is compared to Roundup® ULTRA MAX;

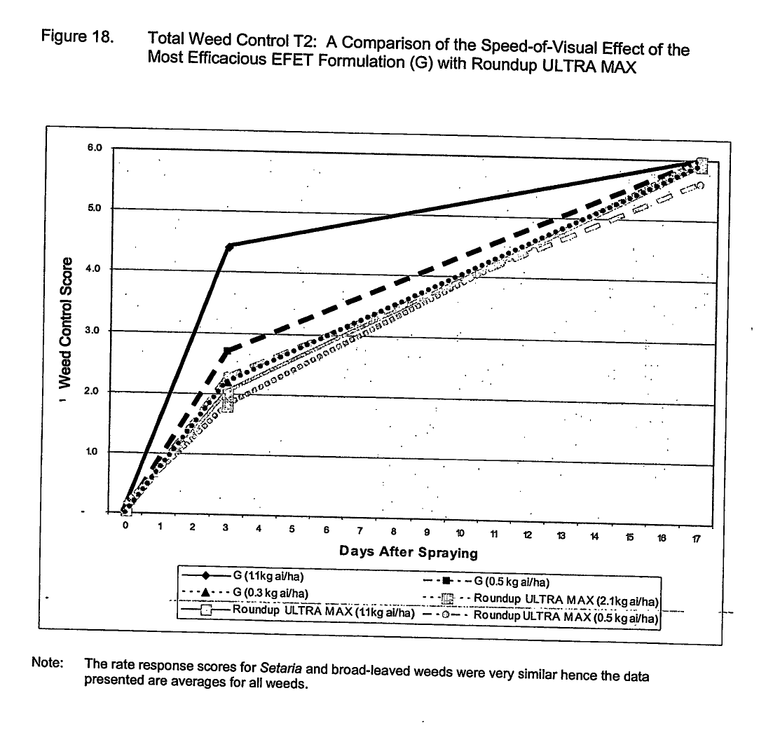

FIG. 18 is a plot diagram showing the speed-of-visual effect of total weed control after a second application of one novel post-emergence herbicidal spray composition prepared in accordance with the present invention, which is compared to Roundup® ULTRA MAX;

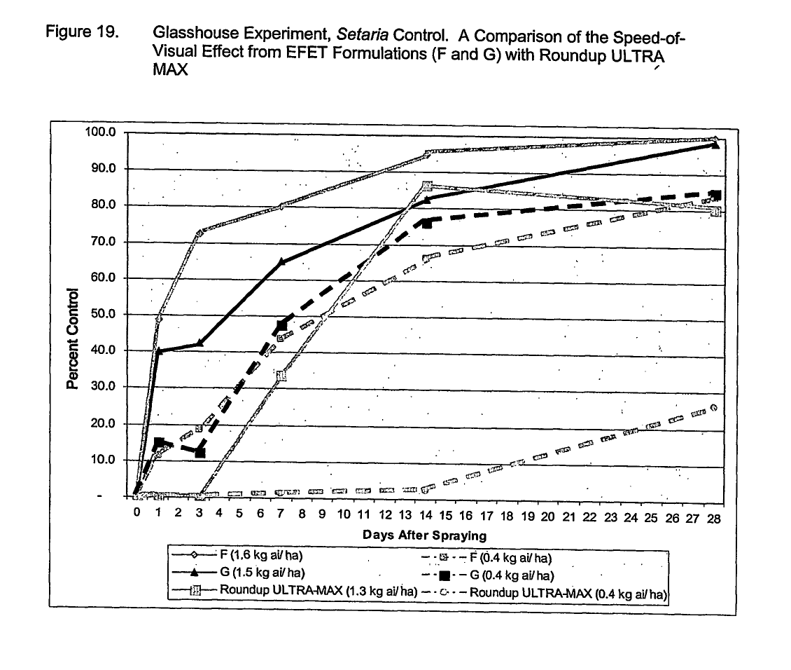

FIG. 19 is a plot diagram showing the speed-of-visual effect of Setaria control in a glasshouse after application of two novel post-emergence herbicidal spray compositions prepared in accordance with the present invention, which are compared to Roundup® ULTRA MAX;

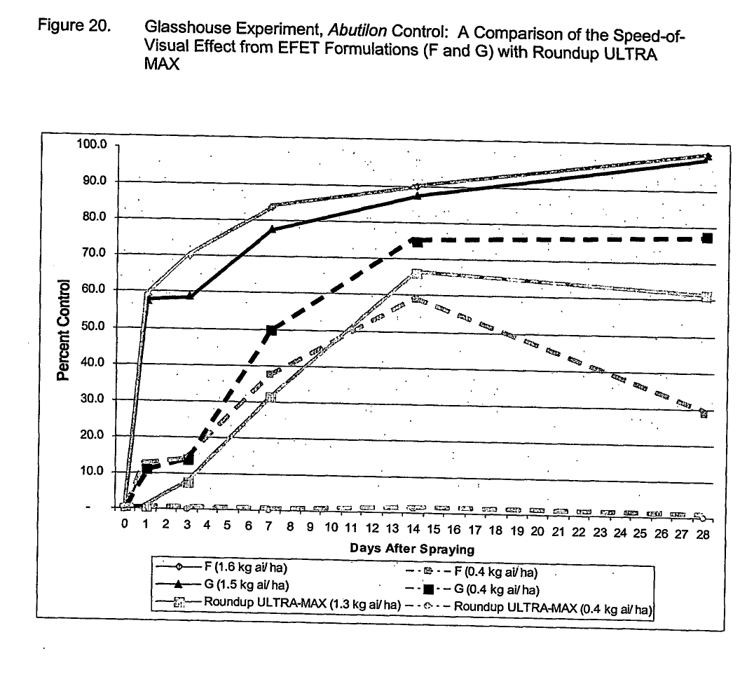

FIG. 20 is a plot diagram showing the speed-of-visual effect of Abutilon control in a glasshouse after application of two novel post-emergence herbicidal spray compositions prepared in accordance with the present invention, which are compared to Roundup® ULTRA MAX;

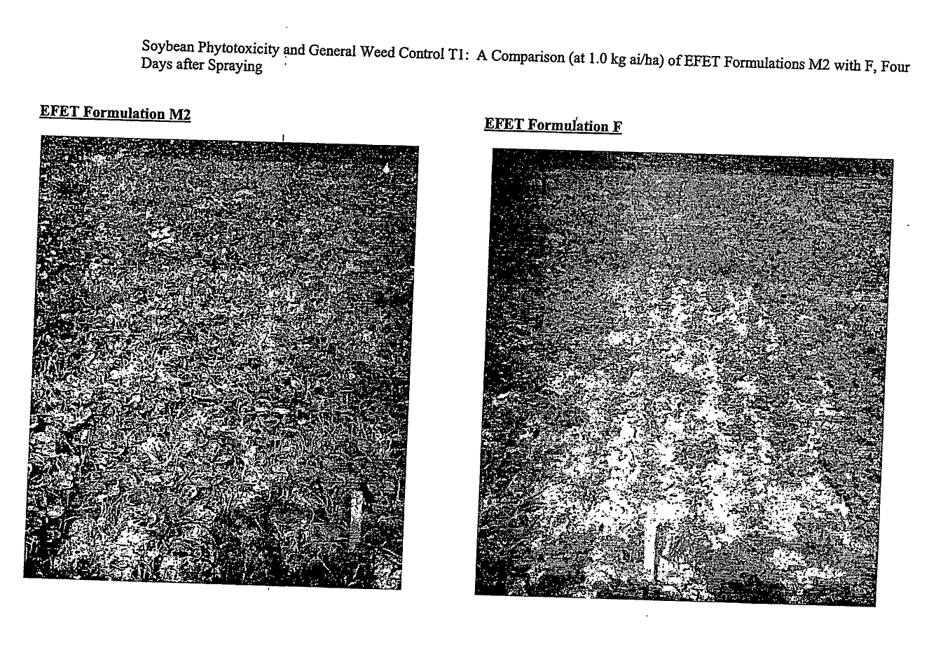

FIG. 21 is a photographic representation of soybean phytotoxicity and general weed control four days after a first application of one novel post-emergence herbicidal spray composition prepared in accordance with the present invention, which is compared to another experimental PMG-based formulation;

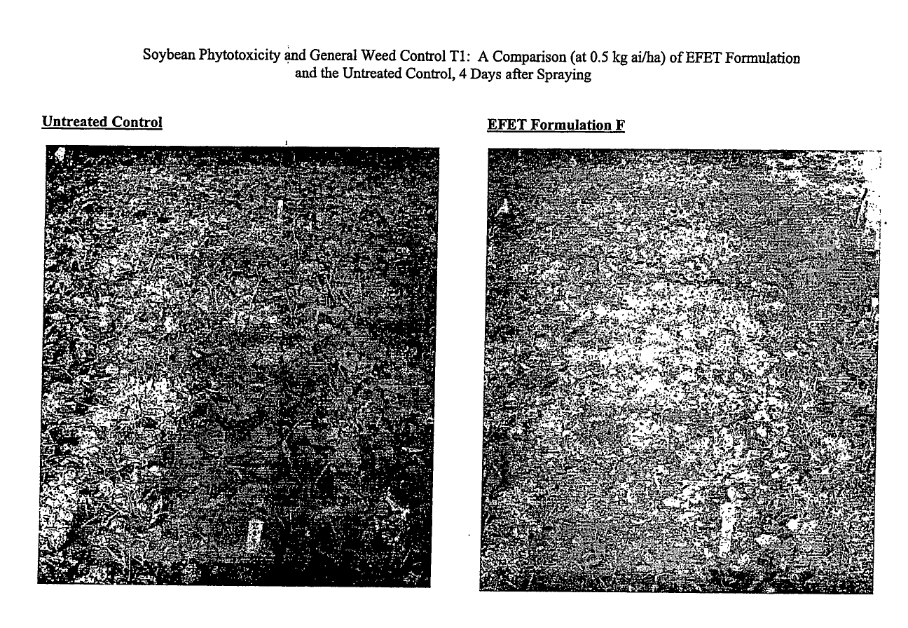

FIG. 22 is a photographic representation of soybean phytotoxicity and general weed control four days after a first application of one novel post-emergence herbicidal spray composition prepared in accordance with the present invention, which is compared to an untreated control;

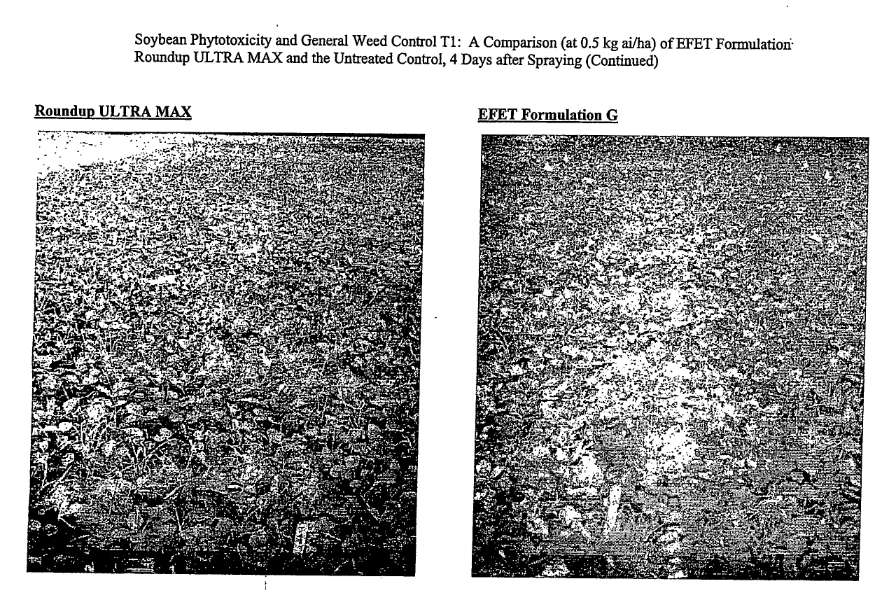

FIG. 23 is a photographic representation of soybean phytotoxicity and general weed control four days after a first application of another novel post-emergence herbicidal spray composition prepared in accordance with the present invention, which is compared to Roundup® ULTRA MAX;

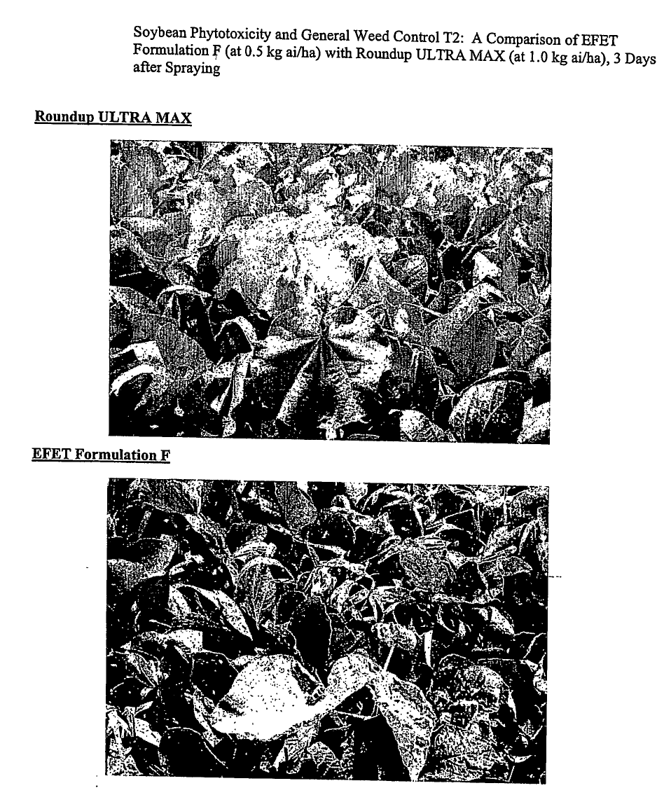

FIG. 24 is a photographic representation of soybean phytotoxicity and general weed control three days after a second application of one novel post-emergence herbicidal spray composition prepared in accordance with the present invention, which is compared to Roundup® ULTRA MAX;

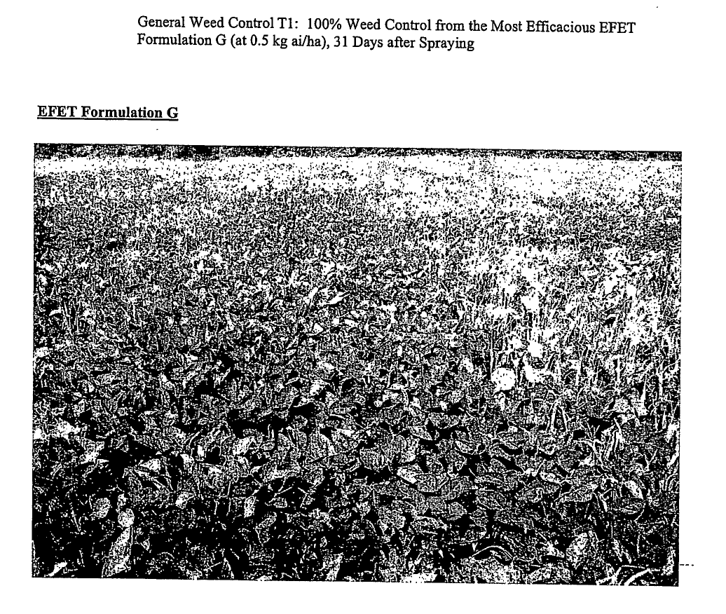

FIG. 25 is a photographic representation of general weed control 31 days after a first application of another novel post-emergence herbicidal spray composition prepared in accordance with the present invention; and

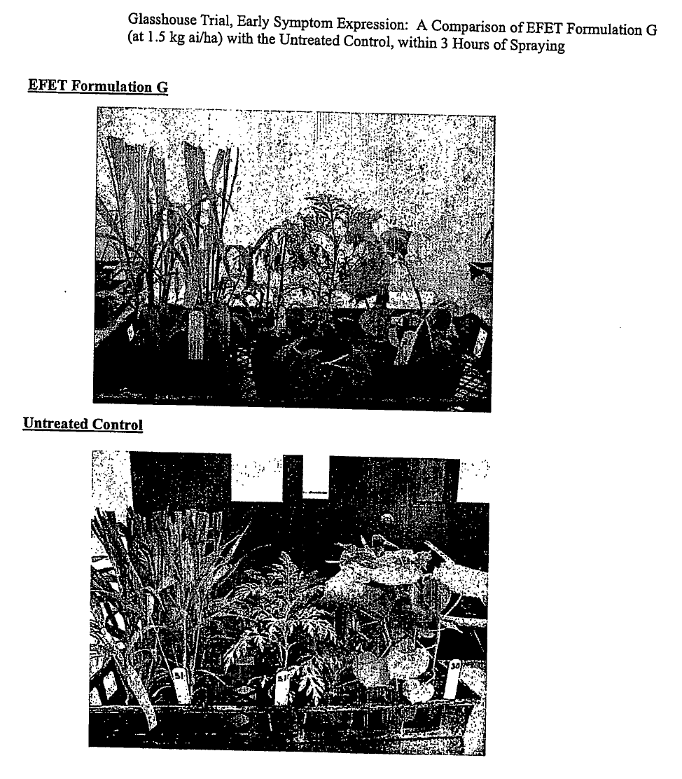

FIG. 26 is a photographic representation of early symptom expression in a glasshouse within three hours of applying one novel post-emergence herbicidal spray composition prepared in accordance with the present invention, which is compared to an untreated control.

Emulsions are dispersions of tiny distinct and discrete droplets of one liquid in another. More specifically, oil-in-water emulsions contain a fatty or oily material that is dispersed in water or in a very polar liquid (e.g., in polyol or glycol). The material inside of emulsion droplets does not move in and out of the droplet. Emulsions form when mechanical energy is applied to affect the dispersion of one liquid in another. A surfactant or emulsifier in an emulsion serves to slow down the rate of emulsion separation. Although some emulsions appear to be quite stable, in time all emulsions will break and release the energy (mechanical) that was exerted to prepare them.

Microemulsions, and more particularly water-continuous microemulsions, can be described as a special case of micellar solutions, wherein solvent and solute molecules are in constant mobility (i.e., thermal motion). In accordance with the present invention, by “micelle” we mean a spherical micelle. (In the chemical literature the word micelle has also been used to describe cylindrical as well as flat micelles. Cylindrical and flat micelles are better known, respectively, as hexagonal (or inverse-hexagonal) (nematic) and lamellar (smectic) lyotropic (i.e., solvent-formed) liquid crystals.) When a certain amount of amphiphilic material (e.g., soap or surfactant) is added to water or other polar liquids (e.g., simple alcohols, glycols and other polyols) the solvating forces of polar solvent molecules act very strongly only on the polar portion or heads of the dissolved amphiphilic molecules. Above a certain concentration (called the critical micelle concentration or “CMC”), the surfactant or soap molecules self-assemble to form spherical aggregates called micelles. The polar heads of the amphiphilic molecules align to the outside, towards the polar liquid. The hydrophobic portions or tails of the amphiphilic molecules are repelled by the polar molecules of the solvent and are thus forced to align close to each other and away from the water or polar liquid, towards the core of the spherical aggregates. In a water-continuous microemulsion, oil molecules are dissolved among the hydrocarbon tails of the amphiphiles. The micelles in water-continuous microemulsions are swollen to a much larger size compared to those in simple micellar solutions.

Non-polar liquids (e.g., liquid hydrocarbons), as compared to water or other similar polar liquids, are very poor solvents for polar materials. Although non-polar liquids may be able to dissolve very small, impractical amounts of the less polar amphiphiles (i.e., amphiphiles of “low hydrophilic-lipophilic balance”), the solubility of an amphiphile in a non-polar liquid is very greatly aided by the addition of a very small amount of water or very polar liquid such as a polyol or glycol. (A quantitative measure of the nature of amphiphiles is provided. As originally defined, it is the ratio of the molecular weight of the polyoxyethylene portion of the amphiphile molecule divided by the molecular weight of the entire molecule and then multiplied by 20. Thus, the least polar amphiphiles have an HLB value of less than about 10. The amiphiphiles of intermediate polarity have HLB values between about 10 and about 15. The most polar amphiphiles have HLB values above about 15. Some very polar amphiphiles have HLB values as high as about 19.0. The latter have 95% of their composition made up of polyoxyethylene.) The molecules of water or polar solvent, by virtue of their thermal motion and physical surroundings, aggregate spontaneously into small molecular groupings throughout the system. These polar groupings attract the polar heads of amphiphile molecules, thus forcing them to align away from the bulk of the non-polar liquid or oil. The weak interaction of oil with the hydrocarbon tails of the amphiphiles is sufficient to solvate them. These resulting aggregates in non-polar liquids are called inverse-micelles. Oil-continuous microemulsions can be described as a special case of inverse-micellar solution. In oil-continuous microemulsions, the water or polar-solvent core of the inverse-micelles may be larger than those of simple inverse-micellar solutions and they may contain a solute.

Microemulsions, like micellar and inverse-micellar solutions, are transparent single-phase liquids, which are at thermodynamic equilibrium and therefore indefinitely stable over time. However, microemulsions may not remain stable if their temperature varies over a wide range. Among oil-continuous microemulsions, those that contain non-aqueous polar solvents possess better temperature stability than those containing water. Contrary to the apparent terminology, microemulsions are not simply emulsions with “micro” droplets inside of them. In microemulsions, the molecules forming the aggregates are continuously moving in and out of the aggregates because of their thermal motion, and microemulsions may contain additional amphiphilic materials. The additional amphiphiles may be other surfactants or co-surfactants such as pentanol or hexanol.

In accordance with one embodiment of the present invention, a non-aqueous, oil-continuous microemulsion is provided comprising at least one oil component, at least one non-aqueous, polar solvent component, at least one amphiphilic material component, and at least one solubilized polar compound component. The polar compound, which is solubilized in the non-aqueous, polar solvent, can be a polar agrochemical complex having herbicidal, insecticidal, fungicidal and/or other like properties. The microemulsion can be applied to a substrate, such as the leaves of a plant, by way of conventional mechanical, aerosol, and electrostatic spray techniques for LV and ULV application of liquid microemulsions containing active compounds such as the polar compound of the present invention.

The oil component of the non-aqueous, oil-continuous microemulsion of the present invention can be a non-volatile oil and typically has a freezing point lower than about 0° C. and a boiling point above about 300° C. The oil component can be selected from alkyl esters of fatty acids, fatty alcohols or esters of dicarboxylic acids (e.g., abietic acid, azelaic acid, fumaric acid, phthalic acid, adipic acid, malonic acid, oxalic acid, succinic acid, and carbonic acid), guerbet alcohols, alcohol acetates, petroleum fractions, aliphatic paraffinic light distillates, hydrocarbon oils, vegetable oils, synthetic triglycerides, triethyl phosphate, and combinations thereof. The alkyl esters of fatty acids can be selected from methyl oleate, ethyl oleate, methyl soyate, ethyl soyate, soybean oil, castor oil, and combinations thereof. The hydrocarbon oil is typically an aliphatic hydrocarbon, an aromatic hydrocarbon, or a combination thereof, and can be a branched-chain saturated or unsaturated hydrocarbon having between about 12 and about 20 carbon atoms. More particularly, the branched-chain hydrocarbon can have about 17 carbon atoms. Examples include diesel oil, Isopar® V (a synthetic oligomeric high-purity isoparaffinic solvent), and Exxate® (an alkyl acetate ester), inter alia, which are available from ExxonMobil Lubricants & Petroleum Specialties Company, Fairfax, Va.

The non-aqueous, polar solvent can be selected from an alcohol, an amine, an alkoxylated amine, an amide, a low-molecular weight ester (e.g., γ-butyrolactone), a nitrile (e.g., benzonitrile), a sulfoxide, sorbitol, urea (in a mixture with the aforementioned), and combinations thereof. The alcohol has more than one hydroxyl group and can be selected from dihydric alcohols, trihydric alcohols, polyhydric alcohols or polyols, and combinations thereof. The dihydric alcohol can be a glycol selected from ethylene glycol, propylene glycol, 1,3-butanediol, a glycol derivative, and combinations thereof. The trihydric alcohol can be a glycerol or a glycerol derivative. The polyhydric alcohol or polyol can comprise the formula CH₂OH(CHOH)ₙCH₂OH, wherein n is between 2 and 5. In addition, components of the non-aqueous polar solvent can be, also, a monosaccharide like glucose or fructose. A disaccharide like sucrose or lactose, also, may be a component of the non-aqueous polar liquid. The amine can be selected from ethylene diamine, ethanolamine, diethanolamine, triethanolamine, and combinations thereof. More specifically, the amine can be tetra(2-hydroxypropyl)ethylenediamine, or Quadrol®, which is available from BASF Corporation, Mount Olive, N.J. The amide can be selected from dimethylformamide, dimethylacetamide, N-methylpyrrolidone, and combinations thereof. The sulfoxide can be dimethylsulfoxide. Preferably, the non-aqueous, polar solvent is one that is approved as inert (for example, N-methylpyrrolidone) by the United States Environmental Protection Agency.

The amphiphilic material can function as a surfactant to reduce the surface and interfacial tension between two immiscible liquids, or as an agricultural adjuvant to enhance the activity of the active ingredient. The amphiphilic material can be selected from cationic surfactants, non-ionic surfactants, quaternary surfactants, amphoteric surfactants, zwitterionic surfactants, and combinations thereof. The cationic surfactant can be an alkylamine having a carbon chain length of between 8 and 18 (including unsaturated carbon chains such as an oleyl group), an alkoxylated amine having between 8 and 18 carbon atoms, such as Ethomeen® S/12 (bis(2-hydroxylethyl)soyaalkylamine), Ethomeen® S/15 (polyoxyethylene (5) soyaalkylamine), and Ethomeen® S/25 (polyoxyethylene (15) soyaalkylamine), which are available from Akzo Nobel Surface Chemistry LLC, Chicago, Ill., and combinations thereof. The non-ionic surfactant can be a polyoxyethylene alcohol such as Brij™ 93 (polyoxyethylene (2) oleyl ether) or Brij™ 97 (polyoxyethylene (10) oleyl ether), a polyoxyethylene sorbitan fatty acid ester such as Tween™ 80 (polyoxyethylene (20) sorbitan monooleate), and combinations thereof, which are available from Uniqema, New Castle, Del., acetylenic and ethoxylated acetylenic diol surfactants such as Surfynol™ 104, SurFynol™ 420, SurFynol™ 440, etc., which are available from Air Products and Chemicals, Inc. of Allentown, Pa., and combinations thereof. In addition, the amphiphilic material can be selected from alkylamines, alkylamine ethoxylates, alkylamine propoxylates, alkylamine propoxylates-ethoxylates, fatty alcohol ethoxylates, fatty alcohol propoxylates, fatty alcohol propoxylates-ethoxylates, fatty acid ethoxylates, fatty acid propoxylates, fatty acid propoxylates-ethoxylates, synthetic long-chain alcohol ethoxylates, synthetic long-chain alcohol propoxylates, synthetic long-chain alcohol propoxylates-ethoxylates, synthetic long-chain acid ethoxylates, synthetic long-chain acid propoxylates, synthetic long-chain acid propoxylates-ethoxylates, alkylphenol ethoxylates, alkylphenol propoxylates, alkylphenol propoxylates-ethoxylates, alkylpolyglucosides, sorbitol esters, sorbitan esters, sorbitol ester ethoxylates, sorbitan ester ethoxylates, polyoxypropylene-polyoxyethylene block copolymers [e.g., BASF's “PLURONICS™”], ethylenediamine-polyoxypropylene-polyoxyethylene block copolymers [e.g., BASF's “TETRONICS™”], and combinations thereof.

The solubilized polar compound can be a polar agrochemical complex and, more particularly, a polar-acidic agrochemical complex, which can be herbicidal in nature. The equivalent acid content of the solubilized polar compound present in the microemulsion is between less than about 5 and about 20% by weight. Examples of such herbicidal, polar-acidic agrochemical complex include amino acids (e.g., glyphosate and glufosinate), phenoxies (e.g., 2,4-D), and combinations thereof. The glyphosate complex can be selected from a glyphosate ester, a glyphosate amide, a glyphosate alkylamide, a glyphosate salt, and combinations thereof. The glyphosate salt can be a glyphosate-amine salt, a glyphosate-alkylamine ethoxylate salt, a glyphosate-alkylaminepropoxylate salt, a glyphosate-alkylaminepropoxylate-ethoxylate salt, a glyphosate sulfonium salt, or a glyphosate sulfoxinum salt, inter alia. The glyphosate-amine salt can be selected from glyphosate-diamine salts, glyphosate-polyamine salts, glyphosate-primary, secondary and tertiary amine salts, glyphosate-quaternary ammonium salts, glyphosate-hydroxylamine salts, glyphosate-ammonium salts, glyphosate-long-chain alkylamine salts, and combinations thereof. The glyphosate-primary amine salt can be selected from a glyphosate-low molecular weight primary amine salt, a glyphosate-high molecular weight primary amine salt, and combinations thereof. Low molecular weight primary amine salts of glyphosate can include those containing up to and including 7 carbon atoms. High molecular weight primary amine salts of glyphosate can include those containing between 8 and 18 carbon atoms, which can be saturated, mono-unsaturated, or poly-unsaturated chains. The glyphosate-low molecular weight primary amine salt can be selected from glyphosate-monomethylamine salts, glyphosate-ethylamine salts, glyphosate-propylamine salts, glyphosate-isopropylamine salts, glyphosate-butylamine salts, glyphosate-amylamine salts, glyphosate-hexylamine salts, glyphosate-heptylamine salts, glyphosate-ethanolamine salts, and combinations thereof. The glyphosate-high molecular weight primary amine salt can be a glyphosate-fatty amine salt, such as glyphosate-oleylamine salt. The glyphosate-secondary amine salt can be selected from glyphosate-low molecular weight secondary amine salts, glyphosate-high molecular weight secondary amine salts, and combinations thereof. The glyphosate-low molecular weight secondary amine salt can be a glyphosate-dimethylamine salt, and the glyphosate-high molecular weight secondary amine salt can be a glyphosate-fatty amine salt. The glyphosate-tertiary amine salt can be selected from glyphosate-low molecular weight tertiary amine salts, glyphosate-high molecular weight tertiary amine salts, and combinations thereof. The glyphosate-low molecular weight tertiary amine salt can be a glyphosate-trimethylamine salt.

In accordance with the present invention, the glyphosate complex can also comprise a glyphosate ester and an alcohol selected from primary alcohols, secondary alcohols, tertiary alcohols, and combinations thereof. In addition, the glyphosate complex can comprise a glyphosate alkylamide and an amine. The amine can be selected from primary amines, secondary amines, and combinations thereof. The secondary amines can include N-methyl-alkylamines.

In accordance with another embodiment of the present invention, a method for preparing a non-aqueous, oil-continuous microemulsion is presented. The polar portion of the microemulsion, which comprises a polar compound such as a polar-acidic agrochemical complex as described above, in soluble form, plus a non-aqueous, polar solvent, which is also described above, is prepared as described below.

A typical method of preparing the soluble form of the polar compound (i.e., polar-acidic agrochemical complex such as glyphosate, glufosinate, or 2,4-D) is the in-situ method. Here, a predetermined amount of the non-aqueous solvent is weighed into a reaction vessel. The (insoluble) solid polar compound is also weighed and added into a reaction vessel. If an amine salt of the polar compound is sought, the desired amine is weighed and added to the reaction container. The amine can be selected from simple amines including diamines and polyamines, primary-, secondary-, and tertiary-amines, ammonium and quaternary-ammonium compounds, hydroxylamines, long-chain alkylamines, and combinations thereof. Sulfonium salts, sulfoxonium salts, amides and esters of the polar compound can also be prepared. An overage (i.e., up to 5% extra) of amine may be used to ensure that variations in amine purity do not become a limiting factor for the neutralization reaction. The reaction may start at room temperature and the mixture may heat up due to the reaction. Typically, the reaction mixture needs warming and stirring to bring the reaction to completion. When the reaction is complete, the entire amount of solid polar compound will go into solution. This description is typical of the preparation of soluble salts of a polar-acidic agrochemical complex, such as PMG. The most convenient procedure is to make a stock solution of the salt in the non-aqueous, polar solvent.

The polar solution may be mixed with an amphiphile. The amphiphile can be any of the amphiphilic materials described above, and typically comprises an alkylamine surfactant (e.g., octylamine, oleylamine), or an alkoxylated amine surfactant such as alkylamine ethoxylates and alkyl-1,3-propanediamine ethoxylates. A predetermined amount of the amine surfactant is weighed and added into the polar solution, which contains the solubilized polar compound, to form an intermediate mixture. This intermediate mixture may appear slightly turbid. Consequently, it typically requires warming and mixing.

The intermediate mixture, described above, and the oil component are mixed together. In one embodiment, a predetermined amount of oil is weighed and a desired amount of the intermediate mixture is added. The combination is then subjected to vigorous mixing to form the oil-continuous microemulsion. When more than one amphiphilic material is desired, a second amphiphilic material can be added to the microemulsion. Typically, this second amphiphilic material is a non-ionic surfactant. In one embodiment, a predetermined amount of such second amphiphilic material is weighed and added to the reaction mixture, which is then subjected to vigorous mixing, to form the non-aqueous, oil-continuous microemulsion, as described herein.

The resultant microemulsion could be further diluted with the oils to give formulations containing lower concentrations of the polar compound. However, since these formulations are typically intended for LV and ULV application, further dilution of the oil-continuous microemulsions is not required. In addition, it is contemplated that the manufacturer of the non-aqueous, oil-continuous microemulsions of the present invention will produce formulations that are ready for application by electrostatic spray techniques. However, it is further contemplated that the intermediate mixture described above could be packaged for later dilution by the end user. Methods for making such a concentrate are described in the modular approach below.

In accordance with yet another embodiment of the present invention, a post-emergence herbicidal spray composition is provided comprising the non-aqueous, oil-continuous microemulsion described herein. As such, the microemulsion can comprise at least one oil component, at least one non-aqueous polar solvent component, at least one amphiphilic material component, and at least one solubilized polar compound component. Each of these components are defined herein, however, more specifically regarding the present post-emergence herbicidal spray composition, the solubilized polar compound component can comprise a polar-acidic agrochemical complex selected from a glyphosate complex, a 2,4-D complex, a glufosinate complex, and combinations thereof, and the oil component can comprise methyl oleate. As illustrated in the examples below, this post-emergence herbicidal spray composition shows superior biological efficacy while reducing the active ingredient dose applied as compared to conventional water-based systemic herbicides, such as Roundup® ULTRA MAX.

In accordance with still another embodiment of the present invention, a method of controlling weeds is provided comprising applying the post-emergence herbicidal spray composition that is described directly above to a target plant. Application of the post-emergence herbicidal spray composition can be performed by either conventional mechanical, non-electrostatic or by electrostatic low-volume or ultra-low volume techniques, which are defined herein.

In accordance with still yet another embodiment of the present invention, a method of improving the uptake and translocation of a systemic herbicidal compound in a target plant is provided which comprises applying a post-emergence herbicidal spray composition to the target plant, that spray composition comprising the non-aqueous, oil-continuous microemulsion described herein. As such, the microemulsion can comprise at least one oil component, at least one non-aqueous polar solvent component, at least one amphiphilic material component, and at least one solubilized polar compound component that comprises a polar-acidic agrochemical complex selected from a glyphosate complex, a 2,4-D complex, a glufosinate complex, and combinations thereof.

The oil component, which lyses plant cell membranes, is a known phytotoxic agent when employed as a contact herbicide. However, without wishing to limit the invention to any particular theory or mechanism of operation, it is believed that the oil component, which can be, for example, an alkyl ester of fatty acid (i.e., methyl oleate) also affects the improved uptake and translocation of the solubilized polar compound (i.e., the systemic herbicidal compound) in the target plant. It is contemplated that the oil component more effectively penetrates the hydrophobic cuticle of the plant as compared to a conventional water-based herbicidal formulation, thereby facilitating the uptake of more systemic herbicide into the plant. This is a result of the particle size (e.g., between about 5 and about 30 microns), pH (slightly acidic), and octonal/water partitioning coefficient (e.g., between about 2 and about 4 k_{ow}) of the polar-acidic herbicidal compound, which enables its transport into the plant phloem (slightly alkaline) more freely, as is described in further detail below.

In accordance with yet still another embodiment of the present invention, the non-aqueous, oil-continuous microemulsion of the present invention can be characterized by a pH that is slightly acidic (such as, for example, less than 7.00 at about 22° C.), which enables transport of the solubilized polar compound component into the phloem of a target plant, which phloem is slightly alkaline. There are two proposed mechanisms by which solutes, both natural and xenobiotic (e.g., pesticides such as glyphosate) might enter the phloem for transport throughout the plant. These mechanisms appear to be species specific. In the first mechanism, or symplastic, the solute may enter any cell (e.g., mesophyll, parenchymal, sieve element/companion cell) in the transport pathway by crossing the cell's membrane. The material is then transported along the pathway [Mesophyll→Vein Epidermal Cells→Vascular Parenchymal Cells→Sieve Element/Companion Cell Complex (SE-CC)] from cell to cell through plasmodesmatal cytoplasmic connections. The driving mechanism for this transport is both passive concentration (osmotic) and actively (membrane carriers) driven. In the second, or apoplastic mechanism, the material is transported from cell to cell up to the SE-CC where it is released into the intracellular space (free space or apoplasm) and then taken up by the SE-CC by active membrane transport mechanisms.

One of the main driving forces for membrane transport here is a proton-co-transport carrier where H+ ions are driven across the membrane by a pH gradient and carry the solute with them. The gradient may be as much as 2 pH units or more where the average pH of the xylem and apoplast may be between about 5.5 and about 5.8 or lower, while that of the phloem (SE-CC) is between about 7.8 and about 8.0. This is maintained by active extrusion of K+ and H+ ions. A slightly acidic material (+charged) will therefore have a higher likelihood of transport into the phloem than a neutral or basic moiety. Further, the pKa's of, for example, glyphosate (2.74, 5.63, and 10.18) would also indicate that at a pH of about 5.5 or lower the molecule would have an overall positive charge.

In accordance with yet still another embodiment of the present invention, the non-aqueous, oil-continuous microemulsion of the present invention can also be characterized by an octonal/water partitioning coefficient of between about 2 and about 4 k_{ow}, which enables transport of the solubilized polar compound component into the phloem of a target plant because it more easily passes through the surrounding membrane. The octonal/water partitioning coefficient, which is usually expressed as a log function, is a measure of the polarity or lipophobicity of a molecule (i.e., the higher the value the more the molecule will partition into the non-polar octonal). Cell membranes are composed paired lipid sheets with embedded protein and carbohydrate molecules. The non-polar portions of the lipid molecules are turned inward creating a non-polar zone into which only other non-polar molecules would be able to pass. For example, glyphosate by itself has a K_{ow} of 0.00000381 while the K_{ow} of methyl oleate, the adjuvant or oil component added to the present formulation, is about 7.45. Based on K_{ow} alone, the methyl oleate easily penetrates the membrane or diffuses into a plant leaf's cuticle, while the passage of glyphosate is much slower. Methyl oleate has been shown to increase penetration of herbicides through plant cuticles (see Santier, S. and Charnel, A. 1996. Weed Research 36(2):167-174). The non-aqueous, oil-continuous microemulsion of the present invention therefore aids in the penetration of the solubilized polar compound (e.g., glyphosate) into the cells of the leaf or the vascular bundles of the target plant, thus shortening the path to the phloem and the time for export from the target leaf to the rest of the plant. Further, the use of the amine salt of glyphosate may add to the amount that penetrates into the cell by allowing the compound to utilize the same membrane carriers present for amino compounds (e.g., amino acids).

Applying the non-aqueous, oil-continuous microemulsion of the present invention in the form of small droplets (e.g., between about 5 and about 30 microns) enables direct penetration of herbicidal compounds into stomata of a target plant, and thus faster penetration into the plant. From the stomata, the surrounding cells within the sub-stomatal cavity have thinner cuticles and cell walls, thus facilitating penetration and enabling faster transport into the mesophyll or vascular tissue of the target plant. The size of the stomatal pore, or aperture, can vary widely between species and can also depend on the physiological state of the leaf. Cross sectional diameters of stomates can vary from 2 to 12 microns in size with the pore areas in excess of 60 square microns. These sizes may allow for direct penetration of droplets smaller than 10 microns into the substomatal cavity inside the leaf. The cells which line this area, usually mesophyll, are responsible for gas (CO₂/H₂O) and water exchange for the plant and will generally have moistened, thinner cell walls with greatly reduced cuticles compared to those on the surface of the leaf. These surfaces will therefore present less of a barrier for penetration of the formulation and will be closer to the sites of translocation from the leaf (SE-CC of minor veins).

It is further contemplated that the oil component of the microemulsion of the present invention insulates the systemic herbicidal compound, which has a slight negative charge, thus further assisting its penetration of the stoma and translocation of the herbicidal compound within the plant. All cell walls are charged because of their composition which will include proteins, amino sugars, and adsorbed ions such as Ca++ or K+. These will tend to give plant cells a net positive charge. This includes the cell walls of the stomatal guard cells which line the aperture. This positive charge is often increased through the exudation of K+ important to the osmotically driven opening and closing of the aperture. The cells may therefore be capable of repelling like charged molecules and small droplets from the aperture. Lipid emulsions are essentially neutral in charge and could pass these cells with no or little electrostatic interference.

Although the oil component has a contact herbicidal effect, it is also contemplated that the relatively small volume of oil component applied to the plant allows systemic herbicidal action to begin before the uptake system of the plant is damaged. By themselves, both systemic herbicides (e.g., glyphosate) and the oil component (e.g., methyl oleate) are phytotoxic. However, where oleic acid will cause direct damage to cell membranes, it will only damage those cell it comes in contact with. In contrast, a systemic herbicide such as, for example, glyphosate works through disruption of the aromatic amino acid (shikimic acid) pathway of the target plant and is capable of intercellular and intracellular transport. Therefore, while it may take days to demonstrate symptomology, it will affect a much greater area within the plant. The assistance in penetration provided by the small amount of oil, (e.g., methyl oleate) in the present formulation could permit a higher “dose” of the systemic herbicidal compound to enter into the symplasm of the plant before the onset of symptomology of the transport system, thus causing greater damage to the entire plant and a higher probability of lethality. As a result, as illustrated in further detail in the examples to follow, this herbicidal spray composition provides superior long term weed control at a lower concentration of active ingredient than conventional aqueous formulations (i.e., Roundup® ULTRA MAX). Moreover, the superior herbicidal performance exhibited by the present embodiment is unaffected by weed growth stage and provides visual symptoms of herbicide activity more rapidly than such conventional aqueous formulations containing a systemic herbicide.

In order that the invention may be more readily understood, reference is made to the following examples, which are intended to illustrate the invention, but not limit the scope thereof.

By way of example, Table 1, below, gives the compositions of two solutions of PMG salts in a non-aqueous solvent.

TABLE 1
PMG Salts in Non-Aqueous Solvent

| Ingredient | Weight % |
|---|---|
| Methylamine (anh.) | 10.70 |
| PMG-Acid | 54.98 |
| Propylene glycol | 34.32 |
| Total | 100.00 |
| Monoethanolamine | 21.67 |
| PMG-Acid | 56.33 |
| Propylene glycol | 22.00 |
| Total | 100.00 |

For the sake of comparison, the solubility of the isopropylamine salt of glyphosate in water is given as 1050 grams of salt in a liter of water at 25° C. and pH 4.3. This is equivalent to 778 grams of equivalent PMG-acid per liter (i.e., per 1000 g water). The weight percent “acid” in this saturated solution would be 37.95%.

Several examples of prepared polyol-in-oil microemulsions are presented below. These formulations possess a range of electric and viscosity properties that make them readily sprayable by electrostatic methods. (See “Pesticide Application Methods”, G. A. Matthews (Author)—Blackwell Publishers, Second Edition (1992): Electrostatically Charged Sprays—Chapter 9, pp. 202-93.) The PMG-based formulations were subjected to comprehensive testing for biological efficacy, including glass-house testing and testing in the field.

A PMG-based formulation can be considered superior if additional value is created by such a formulation. To match current standards a 100% “ultimate death” of a target plant (weed) is the minimum requirement, i.e., complete biological efficacy for a novel PMG-based formulation. Additional value is created by a novel PMG-based formulation if the speed of kill, both perceived as well as actual time to kill, is accelerated through enhanced biological performance. Additional value is also created if novel formulations reduce the amount of user and environmental exposure through a reduction in the required quantities of active ingredient and/or formulated product required, while simultaneously maintaining biological efficacy at least equivalent to current commercial/conventional water-based PMG formulations.

The following tables present the compositions of an assortment of oil-continuous microemulsions. In all cases, the polar portions of these microemulsions are completely non-aqueous and essentially non-volatile liquids. Several of these liquids (or a mixture of such liquids), which include propylene glycol, may be utilized as the polar portion of these non-aqueous microemulsions. The oil portion of some of the following microemulsions is methyl oleate or Isopar® V. The latter is a branched-chain saturated hydrocarbon having about 17 carbon atoms. Several other oils may be used. These are the same oils that have been traditionally used for low-volume and ultra-low volume applications. (See Barlow, F. and Hadaway, A. B. (1974) Some aspects of the use of solvents in ULV formulations. British Crop Protection Council Monograph 11, 84-93.)

TABLE 2
Compositions of Various Oil-Continuous Microemulsions
with Non-Aqueous Polar Parts

| | |
|---|---|
| Ingredients | Weight % |

A

| | |
|---|---|
| PMG Acid | 11.89 |
| Trimethylamine (Anh.) | 4.26 |
| Propylene Glycol | 21.35 |
| Ethomeen ® S/12 | 12.50 |
| Brij ™ 93 | 16.67 |
| Methyl Oleate | 33.33 |
| Total | 100.00 |

B

| | |
|---|---|
| PMG Acid | 10.20 |
| Methylamine (Anh.) | 1.87 |
| Propylene Glycol | 7.93 |
| Ethomeen ® S/12 | 12.50 |
| Brij ™ 93 | 16.67 |
| Methyl Oleate | 50.83 |
| Total | 100.00 |

C

| | |
|---|---|
| PMG Acid | 10.25 |
| Monoethanolamine | 3.92 |
| Propylene Glycol | 10.83 |
| Ethoduomeen ® T/13 | 22.50 |
| Brij ™ 93 | 7.50 |
| Methyl Oleate | 45.00 |
| Total | 100.00 |

TABLE 3
Compositions of Various Oil-Continuous Microemulsions
with Non-Aqueous Polar Parts

| | |
|---|---|
| Ingredients | Weight % |

A

| | |
|---|---|
| PMG Acid | 10.25 |
| Monoethanolamine | 3.92 |
| Propylene Glycol | 10.83 |
| Ethoduomeen ® T/13 | 15.00 |
| Brij ™ 93 | 20.00 |
| Methyl Oleate | 40.00 |
| Total | 100.00 |

B

| | |
|---|---|
| PMG Acid | 10.25 |
| Monoethanolamine | 3.92 |
| Propylene Glycol | 10.83 |
| Ethoduomeen ® T/13 | 10.00 |
| Brij ™ 93 | 40.00 |
| Methyl Oleate | 25.00 |
| Total | 100.00 |

C

| | |
|---|---|
| PMG Acid | 10.25 |
| Monoethanolamine | 3.92 |
| Propylene Glycol | 10.83 |
| Ethoduomeen ® T/13 | 25.00 |
| Brij ™ 93 | 25.00 |
| Isopar ® V | 25.00 |
| Total | 100.00 |

TABLE 4
Compositions of Various Oil-Continuous Microemulsions
with Non-Aqueous Polar Parts

| | |
|---|---|
| Ingredients | Weight % |

A

| | |
|---|---|
| PMG Acid | 10.25 |
| Monoethanolamine | 3.92 |
| Propylene Glycol | 10.83 |
| Ethoduomeen ® T/13 | 15.00 |
| Brij ™ 93 | 30.00 |
| Isopar ® V | 30.00 |
| Total | 100.00 |

B

| | |
|---|---|
| PMG Acid | 12.24 |
| Methylamine (Anh.) | 2.35 |
| Propylene Glycol | 9.41 |
| Ethoduomeen ® T/13 | 10.00 |
| Brij ™ 93 | 40.00 |
| Methyl Oleate | 26.00 |
| Total | 100.00 |

C

| | |
|---|---|
| PMG Acid | 7.82 |
| Trimethylamine (Anh.) | 2.80 |
| Propylene Glycol | 14.04 |
| Ethomeen ® S/15 | 26.02 |
| Tween ™ 80 | 24.66 |
| Methyl Oleate | 24.66 |
| Total | 100.00 |

TABLE 5
Compositions of Various Oil-Continuous Microemulsions
with Non-Aqueous Polar Parts

| | |
|---|---|
| Ingredients | Weight % |

A

| | |
|---|---|
| PMG Acid | 12.23 |
| Methylamine (Anh.) | 2.36 |
| Propylene Glycol | 9.41 |
| Ethoduomeen ® T/13 | 10.00 |
| Brij ™ 93 | 40.00 |
| Methyl Oleate | 26.00 |
| Total | 100.00 |

B

| | |
|---|---|
| PMG Acid | 10.20 |
| Methylamine (Anh.) | 1.96 |
| Propylene Glycol | 7.84 |
| Ethoduomeen ® T/13 | 10.00 |
| Brij ™ 93 | 40.00 |
| Methyl Oleate | 30.00 |
| Total | 100.00 |

C

| | |
|---|---|
| PMG Acid | 10.20 |
| Methylamine (Anh.) | 1.96 |
| Propylene Glycol | 7.84 |
| Ethomeen ® S/12 | 12.50 |
| Brij ™ 93 | 16.50 |
| Methyl Oleate | 51.00 |
| Total | 100.00 |

TABLE 6
Compositions of Various Oil-Continuous Microemulsions
with Non-aqueous Polar Parts

| | |
|---|---|
| Ingredients | Weight % |

A

| | |
|---|---|
| PMG Acid | 10.20 |
| Methylamine (Anh.) | 1.96 |
| Propylene Glycol | 7.84 |
| Ethoduomeen ® T/13 | 10.00 |
| Brij ™ 93 | 40.00 |
| Methyl Oleate | 30.00 |
| Total | 100.00 |

B

| | |
|---|---|
| PMG Acid | 10.25 |
| Monoethanolamine | 3.92 |
| Propylene Glycol | 10.83 |
| Ethoduomeen ® T/13 | 10.00 |
| Brij ™ 93 | 40.00 |
| Methyl Oleate | 25.00 |
| Total | 100.00 |

C

| | |
|---|---|
| PMG Acid | 10.25 |
| Monoethanolamine | 3.92 |
| Propylene Glycol | 10.83 |
| Ethomeen ® S/12 | 12.50 |
| Brij ™ 93 | 16.50 |
| Methyl Oleate | 46.00 |
| Total | 100.00 |

TABLE 7
Identification of Ingredients and Components Used in Formulations

| Name | Nature/Structure | Utility | Source |
|---|---|---|---|
| Brij ™ 93 | Oleyl alcohol/2EO | Surfactant | Uniqema |
| Brij ™ 97 | Oleyl alcohol/10EO | Surfactant | Uniqema |
| Emerest ™ 2301 | Methyl Oleate | Oil Solvent | Cognis |
| Ethoduomeen ® T/13 | Tallow-1,3- | Adjuvant/Surfactant | Akzo-Nobel USA |
| | propanediamine/3EO | | |
| Ethomeen ® S/12 | Soya-amine/2EO | Adjuvant/Surfactant | Akzo-Nobel USA |
| Ethomeen ® S/15 | Soya-amine/5EO | Adjuvant/Surfactant | Akzo-Nobel USA |
| Ethomeen ® S/25 | Soya-amine/15EO | Adjuvant/Surfactant | Akzo-Nobel USA |
| Isopar ® V | Synthetic Isoparaffinic | Oil Solvent | Exxon |
| | Hydrocarbon | | |
| Isopropylamine salt of | | Herbicide | Sigma-Aldrich |
| PMG: 40% Aq. | | | |
| Methylamine [40% Aq.] | | Base | Sigma-Aldrich |
| Monoethanolamine | | Base & Polar Solvent | Sigma-Aldrich |
| PMG Acid | N-Phosphonomethylglycine | Herbicide | Chem Pacific & “in-house” |
| Propylene Glycol | | Polar Solvent | J. T. Baker |
| Trimethylamine [45% Aq.] | | Base | Fluka |
| Tween ™ 80 | Sorbitan Monooleate/20EO | Surfactant | Uniqema |

A glasshouse trial was performed (under controlled conditions) to determine the biological efficacy of the novel PMG-based formulations of the present invention across a broader spectrum (three species) of commonly available weeds. The following weeds were selected as target species: giant foxtail, Setaria faberi, Herm.; common ragweed, Ambrosia elatior, and velvetleaf, Abutilon theophrasti, Medik.

Each glasshouse treatment represents a single application of formulated PMG product to four weeds of each species (a total of 12 weeds treated in each treatment). The weeds measured between 10-12 inches high at the time of treatment. At four weeks after treatment all weeds were removed from their containers, the soil was shaken and then washed off the roots and the remaining biomass was air dried. Once dry, the four weeds from each species were weighed together and the cumulative weight (in grams) was noted for each species in each treatment. The novel PMG formulation results (weights) were compared to conventional glyphosate (Roundup® ULTRA MAX) and to the control (untreated) weeds.

Tables 8 and 9 illustrate the effectiveness of the novel PMG formulations compared to commercial water-based formulations and the controls. The compositions of the novel PMG formulations referenced in Tables 8 and 9 are provided in Tables 8A and 9A below.

TABLE 8
Novel PMG formulations compared to the conventional glyphosate formulation
(and untreated weeds) at ˜25% of the recommended field rate*

| | | | | | | Total of all 3 |
|---|---|---|---|---|---|---|
| | | Volume applied | Ragweed | Velvetleaf | Giant Foxtail | weed species |
| Formulation | AI Dose | per treatment | Total Wt | Total Wt | Total Wt | Total Wt |
| Ref. | (kg/Ha) | (ml) | (grams) | (grams) | (grams) | (grams) |
| D2 | 0.42 | 0.33 | 9.5 | 3.5 | 12.7 | 25.7 |
| B3 | 0.38 | 0.15 | 14.8 | 4.6 | 16.4 | 35.8 |
| K2 | 0.39 | 0.18 | 28.4 | 19.3 | 13.1 | 60.8 |
| Roundup ® | 0.41 | 1.90 | 22.0 | 25.2 | 14.6 | 61.8 |
| Control 1 | Nil | Nil | 35.8 | 67.3 | 186.6 | 289.7 |
| Control 2 | Nil | Nil | 42.4 | 40.8 | 197.6 | 280.8 |

**A sub-optimal rate was used to provide a more accurate indicator of biological effect

TABLE 8A
Compositions of Various Novel PMG Formulations

| Ingredients | Weight % |
|---|---|
| PMG Acid | 4.23 |
| Methylamine (Anh.) | 0.81 |
| Propylene Glycol | 14.96 |
| Ethomeen ® S/12 | 10.00 |
| Brij ™ 93 | 17.00 |
| Methyl Oleate | 53.00 |
| Total | 100.00 |
| D2 | |
| PMG Acid | 4.09 |
| Isopropylamine (Net) | 1.43 |
| Water | 8.28 |
| Ethomeen ® S/15 | 21.56 |
| (This sample has NO Brij ™) | |
| Methyl Oleate | 64.64 |
| Total | 100.00 |
| B3 | |
| PMG Acid | 4.17 |
| Monoethanolamine | 1.60 |
| Propylene Glycol | 7.56 |
| Ethomeen ® S/15 | 20.83 |
| (This sample has NO Brij ™) | |
| Methyl Oleate | 65.84 |
| Total | 100.00 |
| K2 | |

TABLE 9
The top three glasshouse test formulations (of all formulations tested),
which showed the greatest degree of biological control (as determined
by interim visual observations and the ultimate desiccation of the weeds).
Treatments were at ˜100% of recommended field rate.

| | | Volume | | | Giant | Total of all 3 |
|---|---|---|---|---|---|---|
| | | applied per | Ragweed | Velvetleaf | Foxtail | weed species |
| Formulation | AI Dose | treatment | Total Wt | Total Wt | Total Wt | Total Wt |
| Ref | (kg/Ha) | (ml) | (grams) | (grams) | (grams) | (grams) |
| B2 | 1.80 | 0.54 | 1.7 | 1.6 | 3.6 | 6.9 |
| L3 | 1.41 | 0.37 | 3.5 | 2.0 | 5.0 | 10.5 |
| E1 | 1.46 | 0.69 | 9.5 | 3.9 | 1.1 | 14.5 |
| Control 1 | Nil | Nil | 35.8 | 67.3 | 186.6 | 289.7 |
| Control 2 | Nil | Nil | 42.4 | 40.8 | 197.6 | 280.8 |

TABLE 9A
Compositions of Various Novel PMG Formulations

| Ingredients | Weight % |
|---|---|
| PMG Acid | 4.09 |
| Isopropylamine (Net) | 1.43 |
| Water | 8.28 |
| Ethomeen ® S/15 | 21.56 |
| (This sample has NO Brij ™) | |
| Methyl Oleate | 64.64 |
| Total | 100.00 |
| B2 | |
| PMG Acid | 4.08 |
| Methylamine (Anh.) | 0.79 |
| Propylene Glycol | 3.13 |
| Ethomeen ® S/12 | 6.25 |
| Brij ™ 93 | 15.00 |
| Methyl Oleate | 70.75 |
| Total | 100.00 |
| L3 | |
| PMG Acid | 4.17 |
| Monoethanolamine | 1.60 |
| Propylene Glycol | 7.56 |
| Ethomeen ® S/12 | 10.00 |
| Brij ™ 93 | 19.17 |
| Methyl Oleate | 57.50 |
| Total | 100.00 |
| E1 | |

Randomized, multiple-plot field trials were performed on test plots of the annual grass weed giant foxtail, Setaria faberi, Heour. Various novel PMG formulations were compared to a commercial standard, Roundup® ULTRA MAX, applied at the normal recommended field rate (100% of recommended label dose rate), as well as at a suboptimal rate (50% of recommended label dose rate). A single application (treatment) was made when the weeds were 6-12 inches tall. Observations were made at 4 (4-DAT) and at 14 days after treatment (14-DAT).

Tables 10 and 11 illustrate superior field performance of the novel PMG formulations compared to commercial water-based formulations. The compositions of the novel PMG formulations referenced in Tables 10 and 11 are provided in Tables 10A, 10B and 11A below.

TABLE 10
Novel PMG formulations showing superior biological
performance with a reduction in the active ingredient
dose applied (kg/Ha PMG-acid equivalent)

| Formulation | AI Dose | Visual Observation % Effective Kill | |
|---|---|---|---|
| Reference | (kg/Ha) | (4-DAT) | (14-DAT) |
| G2 | 0.50 | 60% | 100% |
| E2 | 0.61 | 60% | 100% |
| E1 | 1.06 | 66% | 100% |
| G1 | 1.09 | 66% | 100% |
| Roundup ® | 2.08 | 55% | 100% |
| (recommended rate) | | | |
| Roundup ® | 1.04 | 33% | 100% |
| (sub-optimal rate) | | | |
| Control Plots | Nil | 0% | 0% |
| (untreated) | | | |

TABLE 10A
Compositions of Various Novel PMG Formulations

| Ingredients | Weight % |
|---|---|
| PMG Acid | 4.17 |
| Monoethanolamine | 1.60 |
| Propylene Glycol | 7.56 |
| Ethomeen ® S/12 | 10.00 |
| Brij ™ 93 | 19.17 |
| Methyl Oleate | 57.50 |
| Total | 100.00 |
| Sample E1 (Applied at 100% field dose) | |
| PMG Acid | 4.09 |
| Isopropylamine (Net) | 1.43 |
| Water | 8.28 |
| Ethomeen ® S/15 | 21.60 |
| (This sample has NO Brij ™) | |
| Methyl Oleate | 64.60 |
| Total | 100.00 |

Sample G1 (Applied at 100% field dose)

TABLE 10B
Compositions of Various Novel PMG Formulations

| Ingredients | Weight % |
|---|---|
| PMG Acid | 2.08 |
| Monoethanolamine | 0.80 |
| Propylene Glycol | 3.78 |
| Ethomeen ® S/12 | 5.00 |
| Brij ™ 93 | 9.58 |
| Methyl Oleate | 78.76 |
| Total | 100.00 |
| Sample E2 | |
| PMG Acid | 4.09 |
| Isopropylamine (Net) | 1.43 |
| Water | 8.28 |
| Ethomeen ® S/15 | 21.60 |
| (This sample has NO Brij ™) | |
| Methyl Oleate | 64.60 |
| Total | 100.00 |

Sample G2 (Applied at half flow-rate as G1)

TABLE 11
Novel PMG formulations showing superior biological performance
with a reduction in the volume of formulated product applied
(ml of formulated product applied per square meter)

| Formulation | Volume | Visual Observation % Effective Kill | |
|---|---|---|---|
| Reference | (ml/sqm) | (4-DAT) | (14-DAT) |
| O3 | 1.25 | 55% | 100% |
| E1 | 2.65 | 66% | 100% |
| G2 | 1.30 | 60% | 100% |
| Roundup ® | 19.20 | 55% | 100% |
| (recommended rate) | | | |
| Control Plots | Nil | 0% | 0% |
| (untreated) | | | |

TABLE 11A
Compositions of Various Novel PMG Formulations

| Ingredients | Weight % |
|---|---|
| PMG Acid | 10.14 |
| Methylamine (Anh.) | 1.97 |
| Propylene Glycol | 7.88 |
| Ethomeen ® S/12 | 12.50 |
| Brij ™ 93 | 16.67 |
| Methyl Oleate | 50.84 |
| Total | 100.00 |
| O3 (Applied at 100% field dose) | |
| PMG Acid | 4.17 |
| Monoethanolamine | 1.60 |
| Propylene Glycol | 7.56 |
| Ethomeen ® S/12 | 10.00 |
| Brij ™ 93 | 19.17 |
| Methyl Oleate | 57.50 |
| Total | 100.00 |
| E1 (Applied at 100% field dose) | |
| PMG Acid | 4.09 |
| Isoproplyamine (Net) | 1.43 |
| Water | 8.28 |
| Ethomeen ® S/15 | 21.60 |
| (This sample has NO Brij ™) | |
| Methyl Oleate | 64.60 |
| Total | 100.00 |

G2 (Applied at half flow-rate as G1)

In addition, the results of a field trial to assess the performance of electric-field-effect-technology (EFET) applications of the post-emergence herbicide glyphosate are presented. The field trial compared several experimental EFET glyphosate formulations, each applied by an EFET device, with the commercial Monsanto formulation Roundup® ULTRA MAX, applied conventionally using a knapsack sprayer, at two times of application.

The EFET formulation G, which was provided in accordance with the present invention, was the most efficacious formulation tested. Overall, control of the predominant weed species on the trial site (Setaria, Abutilon, and Ambrosia) was achieved at 0.5 kg al/ha at both times of application, at least 24 times more efficacious than that provided by Roundup® ULTRA MAX, at volumes of application 20 times lower (10 liters/hectare). The herbicidal performance of EFET formulation G was unaffected by weed growth stage, in contrast to Roundup® ULTRA MAX where higher rates of application were required to control broad-leaved weeds, especially Abutilon, at more advanced growth stages. At these more advanced weed growth stages, EFET formulation G controlled all weeds at 0.3 kg ai/ha, the lowest rate tested, 3-6 times more efficacious than Roundup® ULTRA MAX.

The onset of visible symptoms was also much more rapid and obvious, including necrosis, than that for Roundup® ULTRA MAX. It is contemplated that improvements to the experimental EFET device, and optimization of the novel PMG-based formulation G, are likely to result in further improvements in herbicidal performance.

Two experimental EFET-compatible formulations (M1 and N1) were less aggressive in producing early herbicidal symptoms and less efficacious for long-term weed control than G. The two formulations M1 and N1 were broadly similar in performance at the first time of spray application (T1) and only M1 was selected for further evaluation at the second time of application (T2). At T2, the 10% M1 formulation was diluted with an appropriate solvent to produce a 7.5% formulation, M2, which, surprisingly, significantly improved weed control. M2, however, was significantly less efficacious than the formulation G.

The field trial site was sown to the Roundup Ready® soybean variety 03422310RR; all of the EFET formulations described below were phytotoxic to the crop and would be unsuitable for use on Roundup Ready® crops.

Materials and Methods

The Trial Site

The site selected for the field trial, on the farm of Mr. Ralph Yeager, Somersville, Ohio 43340, USA, was a conventionally-tilled site, previously cropped to wheat, planted with Roundup Ready® soybeans (Var. 03422310RR) at 7″ row spacings.

The scientific rationale for selecting such a site in preference to a non-crop site was to try to separate the herbicidal effect of the formulation adjuvants in the novel formulations (to which Roundup Ready® crops have no bio-engineered resistance) from those of the active ingredient glyphosate (to which Roundup Ready® crops have strong bio-engineered resistance).

The trial site was also selected because the predominant weeds:
Setaria faberi (Giant Foxtail),
Ambrosia elatior (Common Ragweed), and
Abutilon theophrasti (Velvetleaf)
   were the weed species used in the preceding glasshouse screening experiments because of their commercial importance.

The Experimental Treatments

The experimental design was a randomized complete block with three replicates. There were 60 plots in each block. The plot size was 15 ft long by 10 ft wide. The width actually sprayed varied with EFET formulation and was measured for each treatment to determine accurate application rates; it always provided a wide guard area from neighboring plots.

In total, 36 experimental EFET formulations were included in the field trial, comparing 10 different formulation families.

To simplify presentation, the less efficacious or less developed formulations have been excluded; only 12 EFET formulations are reported representing seven EFET formulation families. This abbreviated treatment list is described in Table 12 below.

Each candidate EFET formulation was applied using an experimental EFET device at various rates of application and, usually, at two times of application to evaluate the effect of weed growth stage on herbicidal performance.

The EFET formulations were compared to a modern, conventional glyphosate formulation, Roundup® ULTRA MAX commercialized by Monsanto, applied at the recommended field rate to control the predominant annual weeds, and at one half and at one quarter this rate.

TABLE 12
The Treatment List

| Formulation | Formulation | | Method of | ai Rate | Total Spray | Time of |
|---|---|---|---|---|---|---|
| Family | Code | % ai+ | Application | (kg/ha) | Volume (l/ha) | Application |
| 1 | G | 4.0 | EFET | 1.087 | 27.2 | 1 |
| 1 | G | 4.0 | EFET | 0.503 | 12.6 | 1 |
| 1 | G | 4.0 | EFET | 1.066 | 26.7 | 2 |
| 1 | G | 4.0 | EFET | 0.473 | 11.8 | 2 |
| 1 | G | 4.0 | EFET | 0.348 | 8.7 | 2 |
| 2 | E | 4.0 | EFET | 1.060 | 26.5 | 1 |
| 2 | E | 2.0 | EFET | 0.610 | 30.5 | 1 |
| 2 | E | 4.0 | EFET | 1.496 | 37.4 | 2 |
| 2 | E | 4.0 | EFET | 0.626 | 15.7 | 2 |
| 2 | E | 4.0 | EFET | 0.449 | 11.2 | 2 |
| 3 | F | 1.5 | EFET | 0.977 | 65.1 | 1 |
| 3 | F | 1.5 | EFET | 0.550 | 36.7 | 1 |
| 3 | F | 3.5 | EFET | 1.253 | 35.8 | 2 |
| 3 | F | 3.5 | EFET | 0.638 | 18.2 | 2 |
| 3 | F | 3.5 | EFET | 0.316 | 9.0 | 2 |
| 6 | N2 | 7.5 | EFET | 1.216 | 16.2 | 1 |
| 7 | M1 | 10.0 | EFET | 1.043 | 10.4 | 1 |
| 7 | M1 | 10.0 | EFET | 0.994 | 9.9 | 2 |
| 7 | M1 | 10.0 | EFET | 0.615 | 6.2 | 2 |
| 7 | M1 | 10.0 | EFET | 0.325 | 3.3 | 2 |
| 8 | M2 | 7.5 | EFET | 1.205 | 16.1 | 1 |
| 8 | M2 | 7.5 | EFET | 0.964 | 12.9 | 2 |
| 8 | M2 | 7.5 | EFET | 0.668 | 8.9 | 2 |
| 8 | M2 | 7.5 | EFET | 0.565 | 7.5 | 2 |
| 9 | N1 | 10.0 | EFET | 1.148 | 11.5 | 1 |
| 17 | ULTRA MAX* | 1.1 | Conventional | 2.082 | 192.3 | 1 |
| 17 | ULTRA MAX* | 0.6 | Conventional | 1.043 | 192.3 | 1 |
| 17 | ULTRA MAX* | 0.3 | Conventional | 0.521 | 192.3 | 1 |
| 17 | ULTRA MAX* | 1.1 | Conventional | 2.082 | 192.3 | 2 |
| 17 | ULTRA MAX* | 0.6 | Conventional | 1.043 | 192.3 | 2 |
| 17 | ULTRA MAX* | 0.3 | Conventional | 0.521 | 192.3 | 2 |
| — | Untreated | — | Untreated | — | — | — |
| — | Untreated | — | Untreated | — | — | — |
| — | Untreated | — | Untreated | — | — | — |

+Refers to concentration of ai in applied spray.
*Commercial glyphosate formulation Roundup ® ULTRA MAX (50.2% glyphosate, N(phosphonomethyl)glycine as isopropylamine salt, 49.8% other ingredients).

At the first time of application (T1), for practical reasons, rates of application (kg ai/ha) for the EFET formulations were varied either by dilution with appropriate formulation components or by varying walking speed. (Table 12, above, describes the spray concentrations used.)

At the second time of application (T2), rates of application of all EFET formulations were varied only by walking speed.

At both times of application, the actual rate of application was very accurately determined by measuring the plot area actually sprayed and the actual volume of spray used.

The Prevailing Conditions

The first spray application was made when the soybean crop was in the V-6 to V-7 stage and the weeds were, on average, 12-14 inches tall. The second application was made two weeks later when the soybean crop was at the R-1 stage and the weeds were, on average, 14-21 inches tall.

The conditions at the time of commencement of spraying on both application dates are described below and in Table 13 below.

TABLE 13
The Prevailing Conditions

| | Fist Application | Second Application |
|---|---|---|
| Commence Spraying | 11:00 a.m. | 9:30 a.m. |
| Air Temperature (Start) | 78.3° F. | 81.5° F. |
| Air Temperature (Finish) | Low 90s ° F. | Low 90s ° F. |
| % Relative Humidity (Start) | 64 | 43 |
| Wind Velocity | 4-15 mph | 6-15 mph |
| Soil Type | Clay loam | Clay loam |
| Soil Temperature | 71.2° F. | 74.6° F. |
| Soil Moisture | Dry | Dry |
| % Cloud Cover | 25% | 10% |

After both applications, the weather continued to be dry with the temperature in the low 90s ° F. for prolonged periods.

The gusty winds, up to 15 mph at both applications, were considered marginal-severe with respect to crop spraying guidelines to minimize spray drift.

No fertilizer or maintenance pesticides were applied to the trial area throughout the trial to avoid any possible chemical interactions.

The Spray Devices

The experimental EFET sprayer contained many novel features that are described in a series of PCT International Patent Applications, which are identified by the following Attorney Docket Nos.: BAT 0078 PB/40078.255 entitled “FLUID CONTAINER FOR ELECTROHYDRODYNAMIC SPRAY DEVICE AND METHOD OF USING SAME” and BAT 0079 PB/40078.256 entitled “SPRAY HEAD FOR ELECTROHYDRODYNAMIC SPRAY DEVICE AND ELECTROHYDRODYNAMIC SPRAYER SYSTEM”.

The knapsack sprayer used to apply the conventional Roundup® ULTRA MAX formulation was a conventional field trial device using CO₂ as the propellant.

Details of the application characteristics for both sprayers are described in Table 14 below.

TABLE 14
Sprayer Specification

| | Conventional | | EFET |
|---|---|---|---|
| Operating Pressure | 30 | p.s.i. | Not relevant |
| Nozzle type | Flat fan 8002VS | | Experimental, multi-site |
| Nozzles/Boom | 3 | | 3 |
| Band Width | 5 | feet | 3-6 feet |
| Boom Height | 18 | inches | 6-12 Inches |
| Ground Speed | 3 | mph | Varied |
| Spray Volume | 20 | gal/ac | Varied |
| Spray Water pH | 7.0 | | Not relevant |

Methods of Assessment of Herbicidal Effects

Crop injury and weed control assessments were made by the same assessor for all treatments on all the assessment dates.

The relationship between the dates of assessment and the spray application dates is described in Table 15 below.

TABLE 15
Relationship Between Spray Dates and Herbicidal
Performance Assessment Dates

| Spray | Performance | Days After | |
|---|---|---|---|
| Application Dates | Assessment Dates | Treatment (DAT) | |
| 1st Application | 1st Assessment | 4 DAT | (1st application) |
| 2nd Application | 2nd Assessment | 17 DAT | (1st application) |
| | | 3 DAT | (2nd application) |
| | 3rd Assessment | 31 DAT | (1st application) |
| | | 17 DAT | (2nd application) |

At all times of assessment, herbicidal damage was recorded on a linear 0-6 rating scale where 0=no observable effect and 6=complete control. Ratings were made separately on each occasion for:
grass weed control (exclusively Setaria faberi);
broad-leaved weed control (predominantly Abutilon theophrasti and Ambrosia elatior); and
phytotoxicity to soybean.

In addition, observations were made to record effects on other weed species and other less quantifiable effects.

Other ratings for crop injury and weed control were made by the spray contractor at 7, 14, and 21 DAT.

Results and Discussion

Detailed results are presented in Tables 16-21.

TABLE 16
Results of First Spray Application (T1):
Control of Giant Foxtail (Setaria faberi)

Experimental

| Formulation | ai Rate | Application | Grass Weed Control Score | | |
|---|---|---|---|---|---|
| Family | (kg/ha) | Method | 3 DAT | 17 DAT | 31 DAT |
| G | 1.09 | EFET | 4.0 | 6.0 | 6.0 |
| | 0.89 | EFET | 3.0 | 6.0 | 6.0 |
| | 0.50 | EFET | 3.7 | 6.0 | 6.0 |
| E | 1.06 | EFET | 4.0 | 6.0 | 6.0 |
| | 0.61 | EFET | 3.7 | 6.0 | 6.0 |
| F | 0.98 | EFET | 4.7 | 6.0 | 6.0 |
| | 0.55 | EFET | 3.7 | 6.0 | 6.0* |
| N2 | 1.22 | EFET | 2.7 | 5.7 | 6.0 |
| M1 | 1.04 | EFET | 3.0 | 5.3 | 6.0 |
| M2 | 1.20 | EFET | 3.0 | 5.7 | 6.0 |
| N1 | 1.15 | EFET | 2.7 | 6.0 | 6.0 |
| Monsanto | 2.08 | Conventional | 3.3 | 6.0 | 6.0 |
| Roundup ® | 1.04 | Conventional | 2.0 | 6.0 | 6.0 |
| ULTRA MAX | 0.52 | Conventional | 1.7 | 6.0* | 1.7 |

*Includes one missing plot.
(0-6 score, where 0 = no observable effect, 6 = complete control)

TABLE 17
Results of First Spray Application (T1): Control of Broad-Leaved
Weeds (Abutilon theophrasti and Ambrosia elatior)

| Experimental | | | Weed Control Score | | | |
|---|---|---|---|---|---|---|
| Formulation | ai Rate | Application | 3 | 17 | 31 | Aver- |
| Family | (kg/ha) | Method | DAT* | DAT | DAT | age |
| G | 1.09 | EFET | — | 5.0 | 6.0 | 5.5 |
| | 0.89 | EFET | — | 4.7 | 6.0 | 5.3 |
| | 0.50 | EFET | — | 5.0 | 6.0 | 5.5 |
| E | 1.06 | EFET | — | 4.3 | 6.0 | 5.1 |
| | 0.61 | EFET | — | 4.7 | 4.7 | 4.7 |
| F | 0.98 | EFET | — | 4.3 | 4.7 | 4.5 |
| | 0.55 | EFET | — | 5.0 | 5.0 | 5.0 |
| N2 | 1.22 | EFET | — | 4.7 | 5.3 | 5.0 |
| M1 | 1.04 | EFET | — | 4.3 | 5.3 | 4.8 |
| M2 | 1.20 | EFET | — | 4.0 | 5.0 | 4.5 |
| N1 | 1.15 | EFET | — | 4.3 | 5.7 | 5.0 |
| Monsanto | 2.08 | Conventional | — | 5.0 | 6.0 | 5.5 |
| Roundup ® | 1.04 | Conventional | — | 5.7 | 6.0 | 5.8 |
| ULTRA MAX | 0.52 | Conventional | — | 3.3 | 5.3 | 4.3 |

*Broad-leaved weeds not assessable; relatively uncommon and irregularly distributed.
Note:
Although Velvetleaf (Abutilon theophrasti) and Common Ragweed (Ambrosia elatior) were abundant across the trial site, they were not, in contrast to Giant Foxtail (Setaria faberi), uniformly distributed and this made accurate weed control ratings more difficult. No assessment was attempted at 3 DAT due to apparent sparcity.
(0-6 score, where 0 = no observable effect, 6 = complete control)

TABLE 18
Results of First Spray Application (T1): Phytotoxicity
on Soybean (Var. 03422310RR)

| Experimental | | | Soybean Phytotoxicity Score | | | |
|---|---|---|---|---|---|---|
| Formulation | ai Rate | Application | 3 | 17 | 31 | Aver- |
| Family | (kg/ha) | Method | DAT | DAT | DAT | age |
| G | 1.09 | EFET | 2.0 | 2.0 | 2.0 | 2.0 |
| | 0.89 | EFET | 2.0 | 1.0 | 2.0 | 1.6 |
| | 0.50 | EFET | 1.0 | 1.3 | 1.0 | 1.1 |
| E | 1.06 | EFET | 2.0 | 2.3 | 2.0 | 2.1 |
| | 0.61 | EFET | 1.0 | 2.7 | 1.0 | 1.6 |
| F | 0.98 | EFET | 4.3 | 5.3 | 4.3 | 4.6 |
| | 0.55 | EFET | 3.3 | 5.3 | 3.3 | 4.0 |
| N2 | 1.22 | EFET | 1.3 | 1.7 | 1.3 | 1.4 |
| M1 | 1.04 | EFET | 1.3 | 2.0 | 1.3 | 1.5 |
| M2 | 1.20 | EFET | 2.3 | 2.7 | 2.3 | 2.4 |
| N1 | 1.15 | EFET | 1.7 | 2.3 | 1.7 | 1.9 |
| Monsanto | 2.08 | Conventional | 0 | 1.0* | 0 | 0.3 |
| Roundup ® | 1.04 | Conventional | 0 | 1.3* | 0 | 0.4 |
| ULTRA MAX | 0.52 | Conventional | 0 | 1.0* | 0 | 0.3 |

*No specific symptoms were noted. Positive scores were recorded on one replicate only and were probably an environmental, not a treatment related effect.
(0-6 score, where 0 = no observable effect, 6 = complete control)

TABLE 19
Results of Second Spray Application (T2):
Control of Giant Foxtail (Setaria faberi)

Experimental

| Formulation | ai Rate | Application | Grass Weed Control Score | |
|---|---|---|---|---|
| Family | (kg/ha) | Method | 3 DAT | 17 DAT |
| G | 1.07 | EFET | 4.7 | 6.0 |
| | 0.47 | EFET | 2.7 | 6.0 |
| | 0.35 | EFET | 2.0 | 6.0 |
| E | 1.50 | EFET | 2.0 | 4.7 |
| | 0.63 | EFET | 2.0 | 6.0 |
| | 0.45 | EFET | 1.3 | 3.3 |
| F | 1.25 | EFET | 4.3 | 6.0 |
| | 0.64 | EFET | 3.0 | 6.0 |
| | 0.32 | EFET | 2.7 | 6.0 |
| M1 | 0.99 | EFET | 1.7 | 6.0 |
| | 0.62 | EFET | 1.7 | 5.7 |
| | 0.32 | EFET | 1.0 | 4.7 |
| M2 | 0.97 | EFET | 3.0 | 6.0 |
| | 0.67 | EFET | 2.7 | 6.0 |
| | 0.56 | EFET | 2.3 | 5.7 |
| Monsanto | 2.08 | Conventional | 1.7 | 6.0 |
| Roundup ® | 1.04 | Conventional | 2.0 | 6.0 |
| ULTRA MAX | 0.52 | Conventional | 2.3 | 6.0 |

(0-6 score, where 0 = no observable effect, 6 = complete control)

TABLE 20
Results of Second Spray Application
(T2): Control of Broad-Leaved Weeds

Experimental

| Formulation | ai Rate | Application | Weed Control Scores | |
|---|---|---|---|---|
| Family | (kg/ha) | Method | 3 DAT | 17 DAT |
| G | 1.07 | EFET | 4.0 | 6.0 |
| | 0.47 | EFET | 2.7 | 6.0 |
| | 0.35 | EFET | 2.3 | 6.0 |
| E | 1.50 | EFET | 2.7 | 6.0 |
| | 0.63 | EFET | 3.0 | 6.0 |
| | 0.45 | EFET | 1.0 | 4.0 |
| F | 1.25 | EFET | 4.3 | 6.0 |
| | 0.64 | EFET | 3.7 | 6.0 |
| | 0.32 | EFET | 2.7 | 6.0 |
| M1 | 0.99 | EFET | 2.0 | 4.3 |
| | 0.62 | EFET | 1.7 | 5.3 |
| | 0.32 | EFET | 1.3 | 4.6 |
| M2 | 0.97 | EFET | 2.3 | 5.7 |
| | 0.67 | EFET | 3.0 | 6.0 |
| | 0.56 | EFET | 2.0 | 5.0 |
| Monsanto | 2.08 | Conventional | 2.0 | 6.0 |
| Roundup ® | 1.04 | Conventional | 2.0 | 5.7 |
| ULTRA MAX | 0.52 | Conventional | 2.3 | 5.3 |

(0-6 score, where 0 = no observable effect, 6 = complete control)

TABLE 21
Results of Second Spray Application (T2):
Phytotoxicity on Soybean (Var. 03422310RR)

Experimental

| Formulation | ai Rate | Application | Soybean Phytotoxicity Score | |
|---|---|---|---|---|
| Family | (kg/ha) | Method | 3 DAT | 17 DAT |
| G | 1.07 | EFET | 4.0 | 2.0 |
| | 0.47 | EFET | 2.3 | 1.7 |
| | 0.35 | EFET | 1.7 | 0.7 |
| E | 1.50 | EFET | 1.7 | 1.0 |
| | 0.63 | EFET | 2.0 | 0.7 |
| | 0.45 | EFET | 1.0 | 0 |
| F | 1.25 | EFET | 3.3 | 2.3 |
| | 0.64 | EFET | 2.7 | 1.0 |
| | 0.32 | EFET | 2.0 | 1.0 |
| M1 | 0.99 | EFET | 1.3 | 0 |
| | 0.62 | EFET | 1.0 | 0 |
| | 0.32 | EFET | 0.7 | 0 |
| M2 | 0.97 | EFET | 2.7 | 2.0 |
| | 0.67 | EFET | 1.7 | 0.7 |
| | 0.56 | EFET | 1.3 | 0 |
| Monsanto | 2.08 | Conventional | 0 | 0 |
| Roundup ® | 1.04 | Conventional | 0 | 0.3 |
| ULTRA MAX | 0.52 | Conventional | 0 | 0 |

(0-6 score, where 0 = no observable effect, 6 = complete control)

The field trial was designed to achieve four objectives:
1. To compare the relative field efficacy of several families of experimental EFET glyphosate formulations created in accordance with the present invention, all sprayed using an experimental hand-held EFET boom sprayer.
2. To compare the relative field efficacy of novel EFET glyphosate formulations applied using an experimental hand-held EFET device, with the commercial glyphosate formulation, Roundup® ULTRA-MAX, applied using a conventional, CO₂-propelled, knapsack sprayer.
3. To compare the relative field performance of early applications (weeds 12-14 inches average height) with late applications (weeds 14-21 inches average height) to evaluate the effect of weed growth-stage on the herbicidal performance of EFET applications.
4. To compare the relative speed of herbicidal action of the most efficacious EFET formulations, applied using an experimental EFET device, with that of the commercial glyphosate formulation Roundup® ULTRA MAX, applied using a conventional, CO₂-propelled, knapsack sprayer.
These four objectives are addressed separately in the following sections.

A Comparison of Experimental EFET Formulations

The novel PMG-based formulations of the present invention were compared directly at both times of application. At the first time of application (T1), the formulations were compared only at 1.0 kg ai/ha, in contrast to the second time of application (T2) where the formulations were nominally compared at three rates of application (1.0, 0.5, and 0.25 kg ai/ha).

The results were generally consistent at the two times of application. M1 and N1 were compared only at T1 and were broadly similar in activity. M1, a 10% formulation, was selected for further evaluation at T2, alongside M2, a 7.5% derivative of M1, achieved by solvent-dilution.

M2 was the most “aggressive” formulation in terms both of its speed-of-effect on all weeds, grass and broad-leaved, and its more phytotoxic effects on soybeans. This is manifest photographically in FIG. 21.

Comparisons of the performance of M2 and M1 are shown in FIG. 1. Soybean Phytotoxicity T2: A Comparison of M1 and M2; FIG. 2. Setaria Control T2: A Comparison of M1 and M2; and FIG. 3. Broad-Leaved Weed Control T2: A Comparison of M1 and M2. The difference in performance was most marked for soybean phytotoxicity and is illustrated in FIG. 1, where the values for M2 at 0.6 kg ai/ha are the average values for the 0.67 and 0.56 kg ai/ha rates actually achieved in the field.

The field trial studied weed control in a Roundup Ready® soybean crop (a genetically modified soybean variety (Var. 032422310RR) with a high level of bio-engineered tolerance to the herbicidal action of glyphosate). The soybean variety was not bio-engineered to be tolerant to the EFET formulation components, however, hence the damage to soybeans provides an indicator to the damaging effects of formulation components, in the absence of glyphosate effects. The only difference between M1 and M2 was the addition of a single diluent (i.e., methyl oleate). The increased damage on soybean from M2 over M1 was severe and persistent especially at the higher 1.0 kg ai/ha rate. At this higher rate, the symptoms were also conspicuously different; the soybean leaves showed obvious leaf-edge necrosis with M2 but not M1. It is extremely unlikely that this symptom is a result of run-off on the leaf surface to the leaf edge because of the exceedingly low applied volume (16 liters/hectare). A more probable explanation is that increased uptake and translocation of the formulation to the leaf edge resulted in internal diluent concentrations which were damaging. It is contemplated herein, in accordance with one embodiment of the present invention, that this increased uptake and translocation of the dilutent was associated with increased uptake and translocation of glyphosate. Accordingly, this would explain the surprisingly improved long-term weed control of M2 over M1.

M2 was, however, slower to express herbicidal symptoms, its long-term weed control was inferior and soybean damage was conspicuously less than that from the most efficacious novel EFET formulations F and G.

These comparisons are presented in FIGS. 4-9.

The clear difference in soybean phytotoxicity at T1 is shown photographically in FIG. 21.

The difference in weed control performance is illustrated in FIG. 4 for Setaria control at T1, where the actual field-applied dose of M2 was 1.2 kg ai/ha compared to 1.0 and 1.1 kg ai/ha for F and G respectively.

It is probable that formulation optimization of M2 (and also N2) will lead to improved herbicidal performance.

A Comparison of the Most Efficacious EFET Formulations with Roundup® ULTRA MAX, Applied Conventionally

The results were generally consistent at both application times. The novel EFET formulations F and G were distinctly more “aggressive” in terms of speed-of-effect on weeds (both grass and broad-leaved) and phytotoxic effects on soybean than Roundup® ULTRA MAX. This is vividly illustrated photographically in FIGS. 22-23 and 24 at T1 and T2, respectively.

EFET formulation E was generally less efficacious than either F or G and is not discussed further.

These effects are presented in FIGS. 10-15.

Long-term weed control was also improved substantially compared to Roundup® ULTRA MAX, particularly the control of the broad-leaved weed Abutilon at advanced growth stages at T2. This difference in weed control performance is illustrated on broad-leaved weeds at T2 in FIG. 13.

The difference is further illustrated in FIG. 16, which compares the rate response of the most efficacious EFET formulation G with Roundup® ULTRA MAX at the earliest (3 DAT) and last (17 DAT) dates of assessment. EFET formulation G was clearly superior in weed control performance at all rates of application at both assessment times. Here, the weed species not fully controlled by Roundup® ULTRA MAX at 0.5 and 1.0 kg a/ha was Abutilon theophrasti, the most tolerant weed to glyphosate of the abundant species on the trial site (see Table 22).

There were also clear differences in damage to soybeans at both times of application. This effect was unsurprising because the Roundup Ready® soybean (Var. 03422310RR) was engineered to be tolerant to glyphosate and to the Roundup® ULTRA MAX formulation but it demonstrates the herbicidal potency of the other formulation components in the EFET formulations.

The difference in soybean phytotoxicity was particularly striking, especially at T1, and is illustrated in FIG. 14. Here, Roundup® ULTRA MAX did not produce any phytotoxicity at any rate of application up to 2.1 kg ai/ha at any time of assessment.

The clear conclusion from this single field trial is that the EFET applications were at least as effective or more effective than Roundup® ULTRA MAX at both weed growth stages. This is illustrated in FIG. 16. Overall, EFET formulation G was the most efficacious formulation tested in terms of long-term weed control, though it was less “aggressive” than F in early symptom expression. This combination of properties, the rapid initiation of early visual symptoms without detriment to long-term weed control is unexpected and exceptionally difficult to achieve in glyphosate formulations; it merits further optimization. It is surprising that this early, severe necrosis did not impair the longer-term, systemic activity of glyphosate in EFET formulation G since it is well known that the addition of compounds which cause rapid damage and disruption to weed tissue does not usually result in additive weed control effects but to a reduction in the translocation of glyphosate within the weed (which is an active transport process) and a consequent reduction in long-term weed control. EFET formulation F illustrates this point; it was more aggressive in terms of early damage but less effective at long-term weed control.

At both times of application, EFET formulation G was at least 24 times more efficacious than Roundup® ULTRA MAX and at T2, where the lower rate of 0.3 kg ai/ha was included, at least 3-6 times more efficacious. Optimization of the formulation is likely to result in further improvements in efficacy.

The complete weed control achieved by G at T1 at 0.5 kg ai/ha is shown photographically in FIG. 25.

The Effect of Weed Growth Stage on Herbicidal Performance

The field trial was not designed to evaluate the effect of weed growth stage on herbicidal efficacy in detail. It was designed, however, to determine whether EFET applications were as efficacious on tall weeds (14-21 inches) at advanced growth stages as conventional applications of Roundup® ULTRA MAX applied according to label recommendations.

The Roundup® ULTRA MAX label describes in detail the rates of application required to control weeds at different growth stages. This is summarized below in Table 22 for the main weed species on the trial site.

TABLE 22
Label Recommended Rates (kg ai/ha) for Roundup ® ULTRA
MAX to Control Annual Weed Species of Different Heights (inches)

Maximum Weed Height (inches)

| Weed Species | 3″ | 6″ | 12″ | 18″ |
|---|---|---|---|---|
| Setaria | — | 0.45 | 0.7 | 0.9 |
| Abutilon | 0.7 | 0.9 | 1.4 | >1.4 |
| Ambrosia | — | 0.7 | 0.9 | 1.4 |

The results from the final weed control assessments, comparing weed control performance at T1 (when weeds were, on average, 12-14 inches tall) and T2 (when weeds were, on average, 14-21 inches tall), are presented in Table 23 below.

TABLE 23
Total Weed Control: A Comparison of the Effect of Weed Growth
Stage on the Herbicidal Effectiveness of the Most Efficacious
EFET Formulation (G) with Roundup ® ULTRA MAX

| | Application Rate (kg ai/ha) | | | | | | | |
|---|---|---|---|---|---|---|---|---|
| | 0.3 | | 0.5 | | 1.0 | | 2.0 | |
| Treat- | | Se- | | Se- | | Se- | | Se- |
| ment | blw | taria | blw | taria | blw | taria | blw | taria |
| T1 G | — | — | 6.0 | 6.0 | 6.0 | 6.0 | — | — |
| T1 | — | — | 5.3 | 1.7 | 6.0 | 6.0 | 6.0 | 6.0 |
| ULTRA | | | | | | | | |
| MAX | | | | | | | | |
| T2 G | 6.0 | 6.0 | 6.0 | 6.0 | 6.0 | 6.0 | — | — |
| T2 | — | — | 5.3 | 6.0 | 5.7 | 6.0 | 6.0 | 6.0 |
| ULTRA | | | | | | | | |
| MAX | | | | | | | | |

Note:
blw = broad-leaved weeds

The results presented are the final weed control scores, 31 DAT for T1 and 17 DAT for T2.

The results show that the long-term weed control from EFET formulation G was unaffected by weed growth stage; 0.5 kg ai/ha controlled all weeds completely at both times of application. At the second time of application only, a lower rate of EFET formulation G, 0.3 kg ai/ha, was included and this rate also gave complete long-term weed control. In contrast, Roundup® ULTRA MAX was less effective on broad-leaved weeds (especially Abutilon) at more advanced growth stages where 1.0-2.0 kg ai/ha was required for complete weed control.

At the first spray application (T1), weeds were, on average 12-14″ tall; they had grown to 14-21″ tall at the time of the second application (T2). To consistently control Abutilon theophrasti, the most tolerant weed to glyphosate of the widespread species on the test site, when it is more than 12 inches tall, the recommended rate of Roundup® ULTRA MAX is ca 1.5 kg ai/ha. This is shown in the table below and compared to the most efficacious EFET formulation, G.

TABLE 24
A Comparison of the Application Rate (kg ai/ha) of EFET
Formulation G and Roundup ® ULTRA MAX which
is Required to Provide 100% Control of All Weeds

| | Setaria | | Broad-Leaved Weeds | |
|---|---|---|---|---|
| Formulation | T1 | T2 | T1 | T2 |
| G | Less than 0.5 | Less than 0.3 | Less than 0.5 | Less than 0.3 |
| Roundup ® | 0.5-1.0 | Less than 0.5 | 0.5-1.0 | 1.0-2.0 |
| ULTRA MAX | | | | |

The results of the field trial are, therefore, consistent with the Roundup® ULTRA MAX label recommendation both for in-crop and non-crop applications. The superior performance of EFET formulation G is not related in any way to a less-then-expected performance of Roundup® ULTRA MAX.

A Comparison of the Speed of Herbicidal Action of the Most Efficacious EFET Formulations, with Roundup®) ULTRA MAX Applied Conventionally The onset of visually obvious herbicidal effects was significantly faster with the EFET formulation G than with Roundup® ULTRA MAX at both times of application on all weed species. This is illustrated in FIG. 17 for the first time of application (T1) and in FIG. 18 for the second application (T2). The comparative overall weed control at T2 is illustrated in FIG. 18. The rate response scores for Setaria and broad-leaved weeds were very similar hence the data presented are averages for all weeds.

At both times of application, 0.5 kg ai/ha of the EFET formulation G produced herbicidal symptoms more rapidly than 2.0 kg ai/ha of Roundup® ULTRA MAX without any detriment to long-term herbicidal efficacy. At the second was included, it produced early herbicidal effects equivalent in severity to 1.0-2.0 kg ai/ha of Roundup® ULTRA MAX. This combination of herbicidal properties, early symptom expression, and improved long-term weed control is unexpected and warrants further study and optimization.

The earliest assessment date following both spray applications was three-four days after treatment. Symptom expression was studied closely only at T1. At this time, the EFET formulation G produced conspicuous leaf-edge necrosis on soybean at the higher rate of application (achieved by applying 27 l/ha spray volume) compared to generalized leaf speckling and spotting at the lower rate (0.5 kg ai/ha, achieved by applying 13 l/ha spray volume). Clearly, application volume has a significant effect on the severity and type of symptom expressed. (The leaf-edge necrosis symptom on soybean was also noted with formulation M2 (applied at 16 l/ha) which was produced by solvent-dilution from M1 (applied at 10 l/ha)).

The symptoms on all the weed species were also clearly visible 34 DAT but they varied with species. On Setaria, there was obvious wilting and necrosis; on Ambrosia, significant necrosis and terminal chlorosis; on Abutilon, necrosis and leaf cupping. On the other weeds which were occasionally present, chlorotic terminals were observed on Cirsium, Chenopodium, Taraxacum, and Euphorbia.

Symptoms were much less obvious with Roundup® ULTRA MAX 3-4 DAT but terminal chlorosis was noted on Ambrosia, Abutilon, Cirsium, and Taraxacum.

This rapid expression of symptoms with EFET formulations had been noted earlier in the glasshouse screening trial (Born, G. L., 2002b) which preceded the field trial. The results of this trial are summarized for Setaria and Abutilon in Table 24 and in FIGS. 19 and 20 respectively. The effects on Setaria and Abutilon are described in the table below.

TABLE 25
Glasshouse Trial: Percent Control of Setaria and Abutilon by EFET Formulations
F and G Compared to that from Roundup ® ULTRA MAX

| | kg | 1 DAT | | 3 DAT | | 7 DAT | | 14 DAT | | 28 DAT | |
|---|---|---|---|---|---|---|---|---|---|---|---|
| Formulation | ai*/ha | Setaria | Abutilon | Setaria | Abutilon | Setaria | Abutilon | Setaria | Abutilon | Setaria | Abutilon |
| F | 1.6 | 48.8 | 58.8 | 72.5 | 70.0 | 80.0 | 83.8 | 95.0 | 90.0 | 100.0 | 100.0 |
| | | b | c | c | a | ab | ab | a | abc | a | a |
| G | 1.5 | 40.0 | 57.5 | 42.5 | 58.8 | 65.0 | 77.5 | 82.5 | 87.5 | 98.5 | 100.0 |
| | | c | c | hi | b | cde | abc | d | abc | abc | a |
| Roundup ® | 1.3 | 0 | 0 | 0 | 7.5 | 33.8 | 31.3 | 86.3 | 66.3 | 82.5 | 61.3 |
| ULTRA MAX | | i | I | q | ghi | i | jk | cd | fgh | f | f |

*Actual applied rate.
Note:
Means followed by same letter do not differ significantly (P = .05, Duncan's New Multiple Range Test).
Source: Extracted from Born, G. L., 2002b.

In the glasshouse environment, symptoms were expressed very rapidly indeed. Within three hours, significant leaf blackening was noted on Setaria and leave cupping on Abutilon with both EFET formulations F and G at 1.5 kg ai/ha. These early symptoms are shown photographically in FIG. 26. Roundup® ULTRA MAX produced no symptoms at this time.

It is clear that the speed of onset of symptom expression in the field with EFET formulations occurs very rapidly, perhaps within hours, in contrast to the relatively slow activity of Roundup® ULTRA MAX. The symptoms: leaf blackening, cupping, and necrosis are also more visually obvious than the terminal chlorosis, yellowing, and general debility produced by Roundup® ULTRA MAX.

With the preferred EFET formulation (G), the early symptoms were achieved without any loss of long-term weed control, especially of Abutilon. This combination of herbicidal properties, whilst simultaneously improving rapid damage followed by long-term, systemic weed control is exceptionally difficult to achieve with glyphosate because the early damage normally antagonizes the systemic movement of glyphosate.

3.5 General Discussion

The field trial results demonstrate that experimental EFET-formulations of glyphosate from different formulation families, applied by EFET devices, can significantly out-perform the glyphosate formulation Roundup® ULTRA MAX, applied conventionally, in terms both of speed-of-onset of symptoms and final weed control. The differences were large, apparent at both application times, and consistent for both grass- and broad-leaved weeds.

The field trial is the first reported trial on EFET applications of glyphosate. The results are unexpectedly superior to those in an earlier published report on EFET applications of other herbicides in which Parham, M. R. (1982) described only comparable weed control from EFET applications of the pre-emergence herbicides trifluralin and chloridazon and the post-emergence herbicides fluazifop-butyl, mecoprop, and ioxynil octonoate compared to conventional applications.

The most efficacious experimental EFET formulations, F and G, are unoptimized representatives from different formulation families. Both achieved complete weed control at volumes of application around 10 liters/ha. The percentage active ingredient in the F and G formulations was 3.5% and 4% respectively, providing a significant opportunity for the development of higher concentration formulations in the formulation optimization process. In stark contrast, Roundup® ULTRA MAX was applied at 192 liters/ha (equivalent to 17 gallons/acre), a volume of application in the middle of the water carrier volumes label-recommended by Monsanto for annual weed control (10-40 gallons/acre).

The preferred EFET formulations, therefore, achieved superior (at least 2-4 times) weed control to Roundup® ULTRA MAX at volumes of application twenty times lower and with the real prospect of further spray volume reduction. This has obvious implications for speed and convenience of application.

The lower rates of application of glyphosate (kg ai/ha) required for complete weed control with EFET applications should also result in substantial environmental benefits including reduced contamination of surface waters.

### CONCLUSIONS

The field trial results showed that EFET applications of glyphosate offer substantial improvements over Roundup® ULTRA MAX applied conventionally at equivalent rates of active-ingredient application.

In particular, EFET formulations:

were at least 2-4 times more efficacious than Roundup® ULTRA MAX,
produced herbicidal symptoms much more rapidly and obviously than Roundup® ULTRA MAX, and
were effective at volumes of application 20 times lower (10 liters/hectare).
   It is probable that optimization of the EFET formulations and the EFET application device will result in further improvements in relative performance.
   Oil-Continuous, Non-Aqueous Microemulsions: Exemplary Method of Preparation

The first step in preparing the subject microemulsion formulation involves the active ingredient(s) or pesticide(s). If the pesticide or agrochemical complex as described herein is, itself, an oily liquid, then this initial step is not necessary. If the pesticide is an oil-soluble solid, then it is dissolved in a suitable oil solvent in accordance with the oil component of the present invention. If the pesticide is soluble in a polar solvent, then it is made into a solution with one of the non-aqueous polar solvents described above. If the pesticide, in its original form, is a solid that is not soluble in any solvent, then it may have to be chemically modified, such that a soluble derivative of it is obtained. A solubilizing agent such as a (organic) low-molecular weight amine may be needed to convert the pesticide into a soluble form.

One particular pesticide that, in its original solid form, is practically insoluble in polar as well as non-polar liquids is the herbicide N-phosphonomethylglycine or “PMG”. PMG herbicide is a white solid [zwitterionic] amino-acid. It can be described as having a solubility of 11.6 grams per liter of water at 25° C. and as insoluble in common organic solvents like acetone, alcohol and xylene. The first step in its formulation is to convert it into a soluble form. One available method is to form the salt of PMG with a simple (organic) amine, i.e., (mono-)methylamine, which itself is a gaseous material at room temperature. The gaseous (mono-)methylamine may be dissolved into an essentially non-volatile polar solvent like propylene glycol when the appropriate facilities and safety precautions are available for running such a reaction. A water-solution of the (mono-) methylamine may be equally useful, but the water solvent would have to be stripped off at the end of the reaction by heating the system under vacuum.

A. The Pesticide Concentrate as an Intermediate—a Modular Approach

When a manufacturing process or a preparation involves several complex or difficult steps, running quality control or tracing the source of a possible error may be prohibitively difficult. A modular approach avoids these problems. Such an approach is a preferred embodiment of the present invention.

The first step or module may be aptly described as the “taming” of the insoluble pesticide. It involves an in-situ preparation of a soluble form that yields a concentrated solution of the pesticide in a polar solvent. Propylene glycol, in a predetermined amount, was weighed into an E.M. flask. Monomethylamine (40% aqueous solution) was weighed into the propylene glycol. A stoichiometric amount of amine plus a 2.5% overage was used to ensure that any deviation from the label concentration would not leave any un-reacted PMG. The solution was swirled to mix the ingredients. PMG-acid (the predetermined amount) was then weighed into the flask and the mixture was swirled to wet the powdered solid. The chemical reaction started before any heating was applied. This was evidenced by a rise in temperature of the ingredients upon mixing and by the majority of solid going into solution upon swirling the flask. A magnetic stirring bar was then introduced into the flask and it was set on a heater stirrer. The flask was heated with stirring for about 25 minutes. The reaction temperature was kept about 100° C. and heating was continued until the solid had dissolved. The flask with contents was then cooled in air until its temperature reached about 50° C. The flask was then introduced into a vacuum evaporator. The temperature of the evaporator was kept about 50° C. and the vacuum gage indicated a residual pressure of about 10 mm Hg. After about one hour the flask attained a constant weight indicating that the water had been completely driven off.

This was the procedure used to prepare the (mono-)methylamine salt example described in Table 1 above. The monoethanolamine salt of PMG was prepared in a similar procedure. Monoethanolamine (anhydrous) was used for the reaction. The vacuum evaporation step was not needed in the preparation of the latter compound. The monoethanolamine salt example in Table 1 was prepared according to this procedure.

The concentrates resulting from the latter procedure contain the active ingredient (i.e., the pesticide) in a liquid (solution). These concentrates are stable to storage and they lend themselves, easily, to quality control tests. Furthermore, they may be (warmed and then) pumped or they may be transported (as needed) to other locations where the final formulation can be made.

B. The Polar Sub-Assembly: Concentrate Solution Plus Adjuvant(s)

The solution from part A, above, was used to prepare the polar part of the formulation. The two ingredients, the concentrate plus the adjuvant, were weighed in the predetermined amounts. The addition of the fatty amine (or the amine ethoxylate, amine propoxylate, quaternary amine, etc.) produced the polar part of the formulation. This was a simple mixing procedure. Warming the (viscous) concentrate aided in effecting complete mixing. Steps A and B may be combined into a single step. The resulting polar sub-assembly is a stable liquid that may be stored and used at a later stage for preparing the final formulation.

C. The Non-Polar Sub-Assembly: Oil Plus Surfactant

When a second surfactant (amphiphile) was called for, it was mixed in the predetermined amount with the oil component. This step, also, involved a very simple mixing.

D. The Final Mixing Step: Combining the Two Sub-Assemblies

This final mixing step was the combining of the two sub-assemblies to form the final formulation. Since the final mixture is an oil-continuous recipe, preferably the polar mixture is added into the non-polar mixture followed by warming and vigorous mixing, as needed.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A non-aqueous, oil-continuous microemulsion comprising:
at least one oil component;
at least one non-aqueous polar solvent component;
at least one amphiphilic material component; and
at least one solubilized polar compound component.

2. The microemulsion of claim 1 wherein said oil component is selected from alkyl esters of fatty acids, fatty alcohols, esters of dicarboxylic acids, guerbet alcohols, alcohol acetates, petroleum fractions, aliphatic paraffinic light distillates, hydrocarbon oils, vegetable oils, synthetic triglycerides, triethyl phosphate, and combinations thereof.

3. The microemulsion of claim 2 wherein said esters of dicarboxylic acids are selected from abietic acid, azelaic acid, fumaric acid, phthalic acid, adipic acid, malonic acid, oxalic acid, succinic acid, carbonic acid, and combinations thereof.

4. The microemulsion of claim 2 wherein said alkyl esters of fatty acids are selected from methyl oleate, ethyl oleate, methyl soyate, ethyl soyate, soybean oil, castor oil, and combinations thereof.

5. The microemulsion of claim 2 wherein said hydrocarbon oils are selected from an aliphatic hydrocarbon, an aromatic hydrocarbon, and combinations thereof.

6. The microemulsion of claim 1 wherein said oil component comprises a branched-chain hydrocarbon having between about 12 and about 20 carbon atoms.

7. The microemulsion of claim 1 wherein said non-aqueous, polar solvent is selected from an alcohol, a low-molecular-weight ester, an amine, an alkoxylated amine, an amide, a nitrile, a sulfoxide, sorbitol, urea, and combinations thereof.

8. The microemulsion of claim 1 wherein said non-aqueous, polar solvent comprises an alcohol having more than one hydroxyl group selected from a dihydric alcohol, a trihydric alcohol, a polyhydric alcohol (polyol), and combinations thereof.

9. The microemulsion of claim 8 wherein said dihydric alcohol is selected from ethylene glycol, propylene glycol, 1,3-butanediol, a glycol derivative, and combinations thereof.

10. The microemulsion of claim 8 wherein said trihydric alcohol is a glycerol or a glycerol derivative.

11. The microemulsion of claim 8 wherein said polyhydric alcohol (polyol) comprises the formula CH₂OH(CHOH)ₙCH₂OH, and wherein n is between 2 and 5.

12. The microemulsion of claim 7 wherein said amine is selected from ethylene diamine, ethanolamine, diethanolamine, triethanolamine, and combinations thereof.

13. The microemulsion of claim 7 wherein said amide is selected from dimethylformamide, dimethylacetamide, N-methylpyrrolidone, and combinations thereof.

14. The microemulsion of claim 7 wherein said sulfoxide is dimethylsulfoxide.

15. The microemulsion of claim 7 wherein said low-molecular-weight ester is γ-butyrolactone.

16. The microemulsion of claim 7 wherein said nitrile is benzonitrile.

17. The microemulsion of claim 1 wherein said amphiphilic material is selected from cationic surfactants, non-ionic surfactants, quaternary surfactants, amphoteric surfactants, zwitterionic surfactants, and combinations thereof.

18. The microemulsion of claim 17 wherein said cationic surfactant is selected from an alkylamine having between 8 and 18 carbon atoms, an alkoxylated amine having between 8 and 18 carbon atoms, and combinations thereof.

19. The microemulsion of claim 17 wherein said non-ionic surfactant is selected from a polyoxyethylene alcohol, an alcohol polyoxypropylene-polyoxyethylene, a polyoxyethylene sorbitan fatty acid ester, an acetylenic diol, an ethoxylated acetylenic diol, and combinations thereof.

20. The microemulsion of claim 1 wherein said amphiphilic material is selected from alkylamines, alkylamine ethoxylates, alkylamine propoxylates, alkylamine propoxylate-ethoxylates, fatty alcohol ethoxylates, fatty alcohol propoxylates, fatty alcohol propoxylate-ethoxylates, fatty acid ethoxylates, fatty acid propoxylates, fatty acid propoxylate-ethoxylates, synthetic long-chain alcohol ethoxylates, synthetic long-chain alcohol propoxylates, synthetic long chain acid propoxylate-ethoxylates, synthetic long-chain acid ethoxylates, synthetic long-chain acid propoxylates, synthetic long chain acid propoxylate-ethoxylates, alkylphenol ethoxylates, alkylphenol propoxylates, alkylphenol propoxylate-ethoxylates, alkylpolyglucosides, sorbitol esters, sorbitan esters, sorbitol ester ethoxylates, sorbitan ester ethoxylates, polyoxypropylene-polyoxyethylene block copolymers, ethylediamine-polyoxypropylene-polyoxyethylene block copolymers, and combinations thereof.

21. The microemulsion of claim 1 wherein said solubilized polar compound is a polar agrochemical complex.

22. The microemulsion of claim 21 wherein said polar agrochemical complex is a polar-acidic agrochemical complex is selected from an amino acid, a phenoxy, and combinations thereof.

23. The microemulsion of claim 22 wherein said polar-acidic agrochemical complex is selected from a glyphosate complex, a 2,4-D complex, a glufosinate complex, and combinations thereof.

24. The microemulsion of claim 23 wherein said glyphosate complex is selected from a glyphosate ester, a glyphosate amide, a glyphosate alkylamide, a glyphosate salt, and combinations thereof.

25. The microemulsion of claim 23 wherein said glyphosate complex comprises a glyphosate ester and an alcohol.

26. The microemulsion of claim 23 wherein said glyphosate complex comprises a glyphosate alkylamide and an amine.

27. The microemulsion of claim 1 wherein the equivalent acid content of solubilized polar compound present in said microemulsion is between less than about 5 and about 20% by weight.

28. A method of making a non-aqueous, oil-continuous microemulsion containing a solubilized polar compound comprising:
providing a non-aqueous polar portion comprising said polar compound solubilized in a non-aqueous, polar solvent;
providing an amphiphilic material and mixing said amphiphilic material with said non-aqueous polar portion to produce an intermediate mixture; and
providing an oil component and mixing said oil component with said intermediate mixture to produce said non-aqueous, oil-continuous microemulsion.

29. The method of claim 28 further comprising heating said amphiphilic material with said non-aqueous polar portion.

30. The method of claim 28 wherein said polar compound comprises a polar-acidic agrochemical complex.

31. The method of claim 28 wherein said amphiphilic material comprises a cationic surfactant.

32. The method of claim 31 wherein said cationic surfactant comprises an alkylamine surfactant or an alkoxylated amine surfactant.

33. The method of claim 28 wherein said non-aqueous polar portion is prepared by:
providing said non-aqueous, polar solvent;
providing an insoluble, solid polar compound and combining said polar compound with said non-aqueous, polar solvent to form a reaction mixture; and
providing a compound having an amine, sulfonium, sulfoxonium, amide or ester functional group and mixing said compound with said reaction mixture to form a soluble salt, amide, or ester of said polar compound.

34. The method of claim 33 further comprising heating said compound with said reaction mixture.

35. The method of claim 33 wherein said soluble salt of said polar compound is selected from diamine salts, polyamine salts, primary amine salts, secondary amine salts, tertiary amine salts, ammonium and quaternary ammonium salts, hydroxylamine salts, ammonium salts, long-chain alkylamine salts, sulfonium salts, sulfoxonium salts, and combinations thereof.

36. The method of claim 28 further comprising providing a second amphiphilic material and mixing said second amphiphilic material with said intermediate mixture to produce said non-aqueous, oil-continuous microemulsion.

37. The method of claim 36 wherein said second amphiphilic material comprises a non-ionic surfactant.

38. A post-emergence herbicidal spray composition comprising a non-aqueous, oil-continuous microemulsion, said microemulsion comprising:
at least one oil component;
at least one non-aqueous polar solvent component;
at least one amphiphilic material component; and
at least one solubilized polar compound component.

39. The post-emergence herbicidal spray composition of claim 38 wherein said oil component comprises methyl oleate.

40. The post-emergence herbicidal spray composition of claim 38 wherein said solubilized polar compound component comprises a polar-acidic agrochemical complex selected from a glyphosate complex, a 2,4-D complex, a glufosinate complex, and combinations thereof.

41. The post-emergence herbicidal spray composition of claim 38 wherein said microemulsion is characterized by an octonal/water partitioning coefficient of between about 2 and about 4 k_{ow}.

42. The post-emergence herbicidal spray composition of claim 38 wherein said microemulsion is characterized by a pH of less than 7.00 at about 22° C.

43. A method of controlling weeds which comprises applying a post-emergence herbicidal spray composition to a target plant, said composition comprising a non-aqueous, oil-continuous microemulsion comprising:
at least one oil component;
at least one non-aqueous polar solvent component;
at least one amphiphilic material component; and
at least one solubilized polar compound component that comprises a polar-acidic agrochemical complex selected from a glyphosate complex, a 2,4-D complex, a glufosinate complex, and combinations thereof.

44. The method of claim 43 wherein said applying a post-emergence herbicidal spray composition to a target plant is performed by either conventional mechanical, non-electrostatic or by electrostatic low-volume or ultra-low volume techniques.

45. A method of improving the uptake and translocation of a systemic herbicidal compound in a target plant which comprises applying a post-emergence herbicidal spray composition to said target plant, said composition comprising a non-aqueous, oil-continuous microemulsion comprising:
at least one oil component;
at least one non-aqueous polar solvent component;
at least one amphiphilic material component; and
at least one solubilized polar compound component that comprises a polar-acidic agrochemical complex selected from a glyphosate complex, a 2,4-D complex, a glufosinate complex, and combinations thereof, wherein
said oil component affects said improved uptake and translocation of said solubilized polar compound in said target plant.

46. A method of improving the uptake and translocation of a systemic insecticidal or fungicidal compound in a target plant which comprises applying an insecticidal or fungicidal spray composition to said target plant, said composition comprising a non-aqueous, oil-continuous microemulsion comprising:
at least one oil component;
at least one non-aqueous polar solvent component;
at least one amphiphilic material component; and
at least one solubilized polar compound component that comprises a polar-acidic agrochemical complex, wherein
said oil component affects said improved uptake and translocation of said solubilized polar compound in said target plant.

47. The method of claim 45 or 46 wherein said oil component comprises methyl oleate.

48. A method of controlling weeds which comprises applying a post-emergence herbicidal spray composition to a target plant, wherein
said composition comprises a non-aqueous, oil-continuous microemulsion, and
said applying a post-emergence herbicidal spray composition to a target plant is performed by either conventional mechanical, non-electrostatic or by electrostatic low-volume or ultra-low volume techniques, which deliver a droplet size of between about 5 and about 30 microns to said target plant.

49. A method of controlling insects or fungi which comprises applying an insecticidal or fungicidal spray composition to a target plant, wherein
said composition comprises a non-aqueous, oil-continuous microemulsion, and
said applying an insecticidal or fungicidal spray composition to a target plant is performed by either conventional mechanical, non-electrostatic or by electrostatic low-volume or ultra-low volume techniques, which deliver a droplet size of between about 5 and about 30 microns to said target plant.

50. A method of controlling weeds which comprises applying a post-emergence herbicidal spray composition to a target plant, wherein
said composition comprises a non-aqueous, oil-continuous microemulsion, and
said applying a post-emergence herbicidal spray composition to a target plant is performed by either conventional mechanical, non-electrostatic or by electrostatic techniques, which deliver a volume of formulated product to said target plant, at a volume rate that is less than about 500 lts/ha.
